(19) United States
(12) Patent Application Publication
(10) Pub. No.: US 2025/0162227 A1
(43) Pub. Date: May 22, 2025

(54) POLYURETHANE WASTE BLENDING USING DYNAMIC URETHANE EXCHANGE

(71) Applicant: Northwestern University, Evanston, IL (US)

(72) Inventors: William Robert Dichtel, Evanston, IL (US); Daylan Tyler Sheppard, Evanston, IL (US); Jeremy L. Swartz, Evanston, IL (US)

(21) Appl. No.: 18/841,288

(22) PCT Filed: Feb. 24, 2023
(86) PCT No.: PCT/US2023/063276

§ 371 Date: Aug. 23, 2024

Related U.S. Application Data
(60) Provisional application No. 63/313,722, filed on Feb. 24, 2022.

(51) Int. Cl. B29C 48/00; B29K 75/00; C08J 11/18; C08L 75/06

(52) U.S. Cl. CPC B29C 48/022; C08J 11/18; C08L 75/06; B29K 2075/00; C08J 2375/06; C08J 2475/08

(57) ABSTRACT

Polyurethane waste blending using dynamic urethane exchange and twin-screw extrusion is described. The method may comprise introducing the polyurethane composition into a compounding device, heating the polyurethane composition to an effective bond-exchange temperature, and compounding the polyurethane composition for an effective bond-exchange time where the polyurethane composition comprises two or more network polymers and an effective amount of a polyurethane exchange catalyst permeated within the polyurethan composition.

### CROSS-REFERENCE TO RELATED APPLICATIONS

This application claims benefit of priority to U.S. Application Ser. No. 63/313,722, filed Feb. 24, 2022, the contents of which are incorporated by reference in its entirety.

### STATEMENT REGARDING FEDERALLY SPONSORED RESEARCH

This invention was made with government support under CHE-1901635 and DGE-1842165 awarded by the National Science Foundation. The government has certain rights in the invention.

### BACKGROUND OF THE INVENTION

Polyurethanes (PUs) make up 31% of the commercial crosslinked polymer market value¹ and cover a wide property and application scope, including foams, coatings, and elastomers.² PU waste is typically disposed of by landfilling or incineration to recover energy,³ and their reprocessing or recycling is limited to a small number of commercial processes. PUs have been mechanically downcycled into rebonded foam for carpet underlayers,⁴ but this practice has been phased out due to toxicity concerns. Chemical recycling has proven viable in limited cases through glycolytic⁵⁻⁷ or hydrolytic^{8,9} processes to recover polyols, which are used as feedstocks along with new isocyanates to produce polyurethanes with partial recycled content. Chemical recycling of PUs faces complications from undesired side reactions due to impurities and the polyols produced typically lead to products with inferior mechanical properties compared to those based on newly prepared polyols.^{10,11} Currently, crosslinked PU materials are not reprocessed into higher or similar-value materials directly, which could in principle produce materials with 100% recycled content and significant energy savings. Furthermore, the ability to reprocess and compatibilize blends of PU networks using reprocessing methods amenable to industrial processes is attractive to reduce waste buildup and produce PU products without the direct use of isocyanates.^{12,13}

### BRIEF SUMMARY OF THE INVENTION

Disclosed herein are polyurethane compositions and methods for reprocessing a blended polyurethane network. The method comprises extruding, with a twin extruder, a blend of different polyurethanes in the presence of a carbamate exchange catalyst. The blend of different polyurethanes may comprise a rigid polyurethane and a soft polyurethane. In some embodiments, the mechanical or thermal property of the extrudate is tuned by selecting the weight percent (wt %) of each of the different polyurethanes in the blend. Suitably, the method may further comprise recovering the extrudate and extruding a blend of the extrudate and a second polyurethane in the presence of the carbamate exchange catalyst. In some cases, the recovery and extrusion step are repeated two or more times.

A method for reprocessing a polyurethane composition comprising introducing a polyurethane composition into a compounding device, heating the polyurethane composition to an effective bond-exchange temperature, and compounding the polyurethane composition for an effective bond-exchange time. The polyurethane composition comprises two or more network polymers and an effective amount of a polyurethane exchange catalyst permeated within the polyurethane composition or one or more network polymers. Each of the network polymers comprise a dynamic network formed from an isocyanate constitutional unit and a second constitutional unit having a hydroxyl group capable of reacting with an isocyanate group of the isocyanate constitutional unit to form a urethane bond.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1. Synthesis of (A) rigid polyester polyurethane, (B) soft polyether polyurethane, (C) a mixed polyurethane network prepared directly from the corresponding building blocks for the rigid and soft networks (“as-synthesized blends”), and (D) a mixed polyurethane network prepared by reprocessing a mixture of already prepared rigid and soft networks.

FIG. 2. (A) DMTA of the as-synthesized blends, rigid PU, and soft PU showing that the T_{g} trends linearly with composition and that crosslinking density stays the same for all blends when compared to the starting PUs. (B) Tensile plots of the starting PUs and the as-synthesized blends showing the desired mechanical properties of blending these PUs.

FIG. 3. Tensile plots comparing the three methods of PU blending for (A) 25:75, (B) 50:50, and (C) 75:25. Compression molded plots are dashed, as-synthesized are solid, and extruded are bolded.

FIG. 4. AFM phase imaging of the blended 50:50 PU networks after (A) compression molding, (B) extrusion, and (C) as-synthesized mixtures. Darker areas are more dissipative than lighter areas.

FIG. 5. (A) DMTA plot showing differing blend composition of the extruded materials and how the T_{g} trends linearly with the composition. (B) Representative tensile data showing the differing mechanical properties for the different blends.

FIG. 6. (A) Scheme of the tuning of the composition through multiple extrusion cycles to walk the material from semi-rigid to elastomeric materials. (B) Tensile plots for the four reprocessing cycles that show the resulting materials going from semi-rigid to elastomeric in their respective mechanical properties.

FIG. 7. DMTA of the compression molded PU blends showing a lack of linearity of the glass-transition temperatures to composition.

FIG. 8. Comparison of DMTA plots of the three different methods for preparing 25:75 rigid:soft PU blends.

FIG. 9. Comparison of DMTA plots of the three different methods for preparing 50:50 rigid:soft PU blends.

FIG. 10. Comparison of DMTA plots of the three different methods for preparing 75:25 rigid:soft PU blends.

FIG. 11. DMTA of different sections of extrudate of 50:50 blend of PUs showing how T_{g} and cross-linking density are similar throughout extrusion.

FIG. 12. DMTA of different sections of extrudate of 75:25 blend of PUs showing how T_{g} and cross-linking density are similar throughout extrusion.

FIG. 13. DMTA of different sections of extrudate of 25:75 blend of PUs showing how T_{g} and cross-linking density are similar throughout extrusion.

FIG. 14. AFM friction force imaging in contact mode of 50:50 extruded blend. Darker regions have less friction force than the lighter regions.

FIG. 15 Photograph of the three blends after acid hydrolysis of the polyester PU. Compression molded (left) shows that particles insoluble in acetonitrile resulted after hydrolysis for a day, extruded (right) shows that an oil resulted and as-synthesized (middle) also resulted in an oil.

FIG. 16. GPC refractive index traces of the compression molded, extruded, and presynthesized blends showing that acid hydrolysis of the compression molded material yielded larger molecular weight particles, which shows a more blocky structure and higher degree of phase separation.

FIG. 17. Plot of T_{g} trend to composition showing a linear trend in glass transition temperature to wt % of rigid PU. Linear regression of this data gives an equation of y=0.5372x+8.1778 with an r² of 0.9871.

FIG. 18. FTIR analysis of the multiply reprocessed films showing that, if the films are not dried, ureas can form through side reaction with water (urea stretch shown in shaded region).

FIG. 19. DMTA of the multiple reprocessing cycles after addition of 30 wt % soft PU each reprocessing step.

FIG. 20. Tensile plots of rigid PU as-synthesized (solid) and reprocessed via extrusion (dashed) showing that the mechanical properties can be recovered in pure PU waste as well using this extrusion method.

FIG. 21. Tensile plots of soft PU as-synthesized (solid) and reprocessed via extrusion (dashed) showing that the mechanical properties can be recovered in pure PU waste as well using this extrusion method.

FIG. 22. FTIR spectra of the 50:50 films using the three blending methods, which show no noticeable chemical differences using these three different methods.

FIG. 23. Picture of extruded films showing a light yellow-orange color after extrusion, showing no noticeable degradation qualitatively.

FIG. 24. Picture of starting PU films after being ground up in a coffee grinder.

### DETAILED DESCRIPTION OF THE INVENTION

Recycling crosslinked polyurethanes (PUs) is accomplished through mechanical or chemical processes that are energy intensive or produce plastics of lesser value. Polymer recycling processes are notably intolerant of polymer mixtures, yet the ability to reprocess and compatibilize two or more crosslinked PUs together will make the recycling process more amenable to mixed waste streams while offering an opportunity to tune the properties of the recycled polymer products. The Examples demonstrate blending of a rigid polyester PU and a soft polyether PU in the presence of a carbamate exchange catalyst using twin-screw extrusion to yield materials with tunable mechanical properties based on the feed composition. Their material properties were compared to compression molded reprocessed blends and to blends where the monomers were mixed prior to synthesis. The extruded materials showed similar mechanical and thermal properties to newly prepared blends and had improved mechanical properties compared to the samples reprocessed via compression molding. The morphologies of the blends were observed using phase imaging via atomic-force microscopy to show that there is less phase separation in the extruded materials compared to compression molded blends. The mechanical properties of these materials were tunable from soft to elastomeric to rigid based on the feed composition and this tunability was demonstrated through four consecutive reprocessing cycles, through which the mechanical properties were steadily varied from rigid to soft by incorporating increasing amounts of soft polyether PU material. This blending method for reprocessing mixed waste compatibilizes different PUs and provides a means to tune the mechanical properties of a PU product, even if starting from waste streams of varying composition. As such, this process represents an improved approach for polymer reprocessing.

### Definitions

Several definitions are provided to assist with the understanding of the technology.

“Block” means a portion of a macromolecule, comprising many constitutional units, that has at least one constitutional or configurational feature which is not present in the adjacent portions.

“Branch” means an oligomeric or polymeric offshoot from a macromolecular chain.

“Branch point” means a point on a chain at which a branch is attached.

“Branch unit” means a constitutional unit containing a branch point.

“Catalyst” means a substance that increases the rate of a reaction without modifying the overall Gibbs energy change in the reaction. Suitably the catalyst may be a coordination entity comprising a central atom and one or more ligands joined to the central atom. Suitably the central atom is a metal. “Ligand” means an atom or group joined to a central atom.

“Chain” means a whole or part of a macromolecule, an oligomer molecule, or a block, comprising a linear or branched sequence of constitutional units between two boundary constitutional units, each of which may be either an end-group, a branch point, or an otherwise-designated characteristic feature of the macromolecule.

“Compounding” means to blend or mix a substance, such as any of the polyurethane compositions described herein, within a compounding device. Suitably the substance is compounded at an effective bond-exchange temperature for an effective bond-exchange time.

“Compounding device” means a device for blending or mixing a substance, such as any of the polyurethane compositions described herein. In some embodiments, the compounding device is an extruder, such as a single screw or twin-screw extruder, a mixer, or a kneader. Suitably twin-screw extruders may be a co-rotating or counter-rotating twin-screw extruder. The compounding device may operate in batch or continuous service. Suitably a continuous service compound device may have an inlet, such as a feeding hopper or other suitable feeding mechanism, for introducing the substance into the compounding device, an outlet for extruding the compounded substance, and a compounding zone between the inlet and the outlet for mixing or blending the substance. Suitably the compounding zone is configured so that the substance may be compounded for an effective bond-exchange time. The compounding device may also comprise a heating element so that the substance may be compounded at an effective bond-exchange temperature.

“Constitutional unit” means an atom or group of atoms (with pendant atoms or groups, if any) comprising a part of the essential structure of a macromolecule, an oligomer molecule, a block, or a chain.

“Covalent network” or “covalent polymer network” means a network in which the permanent paths through the structure are all formed by covalent bonds.

“Dynamic network” or “dynamic polymer network” or “covalent adaptable network” means a covalent network that is capable of undergoing bond-exchange reactions at a temperature above an effective bond-exchange temperature. A dynamic network may demonstrate viscoelastic liquid properties above the freezing transition temperature.

“Effective amount of a polyurethane exchange catalyst” means an amount of polyurethane exchange catalyst necessary for the urethane-bond exchange reactions to occur within an effective bond-exchange time at an effective bond-exchange temperature. In some embodiments, the effective amount of polyurethane exchange catalyst allows for an effective-bond exchange time less than or equal to 12 minutes at an effective bond-exchange temperature less than or equal to 160° C. In some embodiments, the mol % of the polyurethane exchange catalyst to the total isocyanate functionality may be less than or equal to 5 mol %. Suitably, the mol % may be less than or equal 4 mol %, 3 mol %, 2 mol %, 1 mol %, or less than 1 mol %. Some materials may contain small amounts of residual catalyst from their manufacture, often 0.1 mol % or less. Such limited quantities of catalyst are typically not enough to enable dynamic bond exchange on a practical time scale. As a result, the effective amount of polyurethane exchange catalyst may be increased post-synthetically by the methods described herein such as swelling or direct mechanical mixing.

“Effective bond-exchange temperature” means a temperature above the freezing transition temperature. The “freezing transition temperature” is the temperature where a material transitions from a viscoelastic solid to a viscoelastic liquid. The effective bond-exchange temperature is lower than the temperature where the dynamic network undergoes irreversible thermal instability or degradation. In some embodiments, the effective bond-exchange temperature is greater than the freezing transition temperature and less than or equal to 300° C. Suitably the effective bond-exchange temperature may be less than or equal to 275° C., 250° C., 240° C., 230° C., 220° C., 210° C., 200° C., 190° C., 180° C., 170° C., 160° C., 150° C., 140° C., 130° C., 120° C., 110° C., 100° C., or less than 100° C.

“Effective bond-exchange time” means a time sufficient for urethane-bond exchange reactions to occur. The effective bond-exchange time may be determined by monitoring the stress decay of a polyurethane composition. Suitably, a minimum effective bond-exchange time may be determined as the time necessary for the stress relaxation modulus to relax to at least 37% (1/e) of its initial value at an effective bond-exchange temperature. In some embodiments, the effective bond-exchange time is less than or equal to 60 minutes. The effective bond-exchange time may be less than or equal to 50 minutes, 45 minutes, 40 minutes, 35 minutes, 30 minutes, 25 minutes, 20 minutes, 15 minutes, 12 minutes, 10 minutes, or less than 10 minutes. In some embodiments, the effective-bond exchange time is less than or equal to 12 minutes at an effective bond-exchange temperature of less than or equal to 160° C.

“Foam” means a multiphasic material comprising gas dispersed in a polymer. The foam may be formed by trapping pockets of gas in a solid or liquid. Foams may be prepared by physical or chemically blowing. In some embodiments, the foam may be a closed-cell foam where the gas forms discrete, completely surrounded pockets. In other embodiments, the foam may be an open-cell foam where the gas pockets are interconnected. Suitably the polymer is a polyurethane (“polyurethane foam”).

“Inorganic polymer” means a polymer or polymer network with a skeletal structure that does not include carbon atoms. Examples include, without limitation, polyphosphazenes, polysilicates, polysiloxanes, polysilanes, polysilazanes, polygermanes, and polysulfides.

“Isocyanate constitutional unit” means a constitutional unit comprising at least one isocyanate group, i.e., —NCO. Suitably the isocyanate constitutional unit may comprise more than one isocyanate group such as two, three, four, or more than four isocyanate groups. The isocyanate constitutional unit may be a prepolymer molecule or a branch unit. Suitably the second constitutional unit may function as both a prepolymer molecule and a branch unit. In some embodiments, the isocyanate constitutional unit is an aromatic isocyanate constitutional unit. As used herein, an “aromatic isocyanate constitutional unit” means an isocyanate constitutional unit having an isocyanate group pendant from an aryl group such a phenyl or other aromatic ring. In other embodiments, the isocyanate constitutional unit is an aliphatic isocyanate constitutional unit. As used herein, an “aliphatic isocyanate constitutional unit” means an isocyanate constitutional unit having an isocyanate group pendant from an aliphatic group such an acyclic or cyclic alkyl, an acyclic or cyclic alkenyl, or an acyclic or cyclic alkynyl group.

“Lewis acid” means a molecular entity (and the corresponding chemical species) that is an electron-pair acceptor and therefore able to react with a Lewis base to form a Lewis adduct, by sharing the electron pair furnished by the Lewis base.

“Linear chain” means a chain with no branch points between the boundary units.

“Macromolecule” or “polymer molecule” means a molecule of high relative molecular mass, the structure of which essentially comprises the multiple repetition of units derived, actually or conceptually, from molecules of low relative molecular mass.

“Mechanically processed” means to mechanically alter a substance, e.g., by mechanically mixing, grinding, cutting, chopping, or applying some other form of mechanical force. Suitably, the substance such as the polyurethane compositions described herein may be mechanically processed to fragment the substance into pieces, grains, or powders.

“Monomer” means a substance composed of monomer molecules.

“Monomer molecule” means a molecule which can undergo polymerization, thereby contributing constitutional units to the essential structure of a macromolecule.

“Monomeric unit” means the largest constitutional unit contributed by a single monomer molecule to the structure of a macromolecule or oligomer molecule.

“Network” means a highly ramified macromolecule in which essentially each constitutional unit is connected to each other constitutional unit and to the macroscopic phase boundary by many permanent paths through the macromolecule, the number of such paths increasing with the average number of intervening bonds; the paths must on the average be co-extensive with the macromolecule.

“Network polymer” means a polymer composed of one or more networks.

“Oligomer molecule” means a molecule of intermediate relative molecular mass, the structure of which essentially comprises a small plurality of units derived, actually or conceptually, from molecules of lower relative molecular mass.

“Organic polymer” means a polymer or polymer network with a skeletal structure that includes carbon atoms. Examples include, without limitation, polyethers, polyesters, polycarbonates, polyacrylates, polyolefins, and polybutadienes.

“Polymer” means a substance composed of macromolecules.

“Polymerization” means a process of converting a monomer or a mixture of monomers into a polymer.

“Prepolymer molecule” means a macromolecule or oligomer molecule capable of entering, through reactive groups, into further polymerization, thereby contributing more than one constitutional unit to at least one type of chain of the final macromolecules.

“Polyurethane composition” means a dynamic network formed from urethane bonds that are capable of undergoing urethane bond-exchange reactions. The polyurethane compositions comprise a network urethane-containing polymer and a polyurethane exchange catalyst permeated within the polyurethane composition or one or more network polymers. The network polymer may be formed from isocyanate constitutional units and a second constitutional unit having two or more hydroxyl groups capable of reacting with the isocyanate group of the isocyanate constitutional unit. The second constitutional unit may be a prepolymer molecule or a branch unit. Suitably the second constitutional unit may function as both a prepolymer molecule and a branch unit. The prepolymer molecule is an organic polymer molecule or an inorganic polymer molecule such as a polyether, a polyester, a polycarbonate, a polyacrylate, a polyolefin, a polybutadiene, a polysulfide, or a polysiloxane having one or more hydroxyl groups capable of reacting with an isocyanate group. When the prepolymer molecule also functions as a branch unit, the prepolymer molecule has a three or more hydroxyl groups capable of reacting with isocyanate groups and typically a plurality of hydroxyl groups in proportion to the number of constitutional units of the prepolymer molecule. The network polymer may also be formed from urethane-containing monomers featuring other polymerizable groups, including but not limited to, acrylates, methacrylates, or other polymerizable olefins.

“Polyurethane exchange catalyst” means a catalyst that increases the rate of a polyurethane bond-exchange reaction. In some embodiments, the polyurethane bond-exchange reaction is a carbamate-exchange reaction. Catalysts suitable for use with a carbamate-exchange reaction may be termed a carbamate exchange catalyst. Suitable metals for the catalyst include Sn, Bi, Fe, Zr, Ti, Hf, Al, Zn, Cu, Ni, Co, Mn, V, Sc, Y, Ce, or Mo. Suitable ligands for the catalyst include carboxylate, alkoxide, 1,3-diketone, 1,2-diketone, trifluoromethanesulfonate, trifluoromethanesulfonamide, amido, sulfonate, halide, catecholate, phosphine, salicylidene diamine, carbonate, phosphate, nitrate, cyclopentadiene, pyridine, hydroxide, or any combination thereof. Exemplary ligands include acetylacetonate (acac), isopropoxide (OiPr), neodecanoate (neo), laurate, ethylhexanoate, and 2,2,6,6-Tetramethyl-3,5-heptanedione (tmhd).

“Thermosetting polymer” or “thermoset” is a polymer that is irreversibly hardened by curing from a soft solid of viscous liquid prepolymer or resin.

“Vitrimer” means a network polymer that can change its topology by thermally activated bond-exchange reactions. At elevated temperatures, the bond-exchange reactions occur at an effectively rapid rate and the network polymer has properties of a viscoelastic liquid. At low temperatures, the bond-exchange reactions are slow and the network polymer behaves like a thermosetting polymer.

“Soft polymer” is a polymer having one or more of the following properties:
(1) a tensile stress of less than 5.0 MPa, or in some embodiments, a tensile stress less than, or equal to, 4.5 MPa, 4.0 MPa, 3.5 MPa, 3.0 MPa, 2.5 MPa, 2.0 MPa, 1.5 MPa, 1.0 MPa, or 0.5 MPa; and/or
(2) a strain at break from 150% to 500%, or in some embodiments, a strain at break from 160% to 475%, from 170% to 450%, from 180% to 425%, from 190% to 400%, from 200% to 375%, from 200% to 350%, from 200% to 325%, or from 200% to 300%; and/or
(3) a Young's modulus of less than 5 MPa, or in some embodiments, a Young's modulus less than, or equal to, 4.9 MPa, 4.8 MPa, 4.7 MPa, 4.6 MPa, 4.5 MPa, 4.4 MPa, 4.3 MPa, 4.2 MPa, 4.1 MPa, 4.0 MPa, 3.9 MPa, 3.8 MPa, 3.7 MPa, 3.6 MPa, 3.5 MPa, 3.4 MPa, 3.3 MPa, 3.2 MPa, 3.1 MPa, 3.0 MPa, 2.9 MPa, 2.8 MPa, 2.7 MPa, 2.6 MPa, 2.5 MPa, 2.4 MPa, 2.3 MPa, 2.2 MPa, 2.1 MPa, 2.9 MPa, 2.8 MPa, 2.7 MPa, 2.6 MPa, 2.5 MPa, 2.4 MPa, 2.3 MPa, 2.2 MPa, 2.1 MPa, 2.0 MPa, 1.9 MPa, 1.6 MPa, 1.4 MPa, 1.2 MPa, or 1.0 MPa; and/or
(4) a glass-transition temperature less than 20° C., or in some embodiments, a glass-transition temperature less than, or equal to, 18° C., 16° C., 14° C., 12° C., 11° C., 10° C., 8° C., 5° C., 3° C., or 0° C.

“Elastomeric polymer” is a polymer having one or more of the following properties:
(1) a tensile stress from 5 MPa to 15 MPa, or in some embodiments, from 6 MPa to 13 MPa, from 7 MPa to 11 MPa, or from 7 MPa to 10 MPa; and/or
(2) a strain at break from 100% to 150% or in some embodiments, from 110% to 150%, from 100% to 140%, from 110% to 140%, from 100% to 130%, from 120% to 130%, or from 100% to 120%; and/or
(3) a Young's modulus from 5 MPa to 100 MPa, from 5 MPa to 15 MPa, from 5 MPa to 20 MPa, from 5 MPa to 30 MPa, from 5 MPa to 40 MPa, from 5 MPa to 50 MPa, from 5 MPa to 60 MPa, from 5 MPa to 70 MPa, from 5 MPa to 80 MPa, or from 5 MPa to 90 MPa; and/or
(4) a glass-transition temperature from 20° C. to 35° C., from 22° C. to 33° C., from 25° C. to 35° C., from 30° C. to 35° C., from 20° C. to 30° C., or from 20° C. to 25° C.

“Hard polymer” or “rigid polymer” is a polymer having one or more of the following properties:
(1) a tensile stress greater than 15 MPa, or in some embodiments, a tensile stress greater than, or equal to, 18 MPa, 20 MPa, 23 MPa, 26 MPa, 30 MPa, 33 MPa, 36 MPa, 40 MPa, 42 MPa, 44 MPa, or 46 MPa; and/or
(2) a strain at break less than 100%, or in some embodiments, a strain at break less than, or equal to 95%, 90%, 85%, 80%, 75%, 70%, 65%, 60%, 55%, 50%, 45%, 40%, 35%, 30%, 25%, 20%, 15%, 10%, 5%, 3%, or 1%; and/or
(3) a Young's modulus greater than 100 MPa, or in some embodiments, a Young's modulus greater than, or equal to, 200 MPa, 300 MPa, 400 MPa, 500 MPa, 600 MPa, 700 MPa, 800 MPa, 900 MPa, 1000 MPa, 1100 MPa, 1200 MPa, 1300 MPa, 1400 MPa, 1500 MPa, 1600 MPa, 1700 MPa, 1800 MPa, or 2000 MPa; and/or
(4) a glass-transition temperature greater than 35° C., or in some embodiments, a glass-transition temperature greater than, or equal to, 38° C., 40° C., 43° C., 45° C., 48° C., 60° C., 63° C., 64° C., 70° C., 73° C., 75° C., 80° C., or 90° C.

In some embodiments, the tunable mechanical properties of the extrudate include Young's modulus, toughness, strain-at-break, stress-at-break and/or elasticity. In some embodiments, the tunable thermal properties of the extrudate include glass transition temperature and/or decomposition temperature.

### Methods and Composition for Reprocessing Polyurethane Compositions

Covalent adaptable networks (CANs) have the potential to address the challenge of recycling crosslinked polymers. CANs are polymer networks whose covalent crosslinks undergo degenerate exchange in response to a stimulus, most often heat. These exchanges allow these materials to be reprocessed at elevated temperatures, in contrast to conventional thermosets that are not reprocessable.^{14,15} CANs exhibit mechanical properties similar to traditional thermosets at their usage temperatures, yet are amenable to reshaping under conditions when bond exchange accelerates.¹⁶⁻¹⁹ Lewis acid metal catalysts, such as dibutyltin dilaurate (DBTDL) or bismuth (III) neodecanoate, catalyze carbamate exchange in which the urethane crosslinks dissociate to isocyanates and alcohols, which reform carbamate crosslinks as the sample is reprocessed.²⁰ Most CANs are typically reprocessed using compression molding while some of these materials are amenable to more industrially relevant injection molding and screw extrusion processing.^{21,22} Twin-screw extrusion to has been used to reprocess model and commercial PU foams into films by post-synthetically introducing DBTDL as a carbamate exchange catalyst.²³ The extruded PUs had no loss of mechanical properties when compared to films synthesized from the same monomers. However, this process converts commercial PU foams to soft, elastomeric films, which are not used for a specific commercial purpose. Additionally, PU foam waste might also be mixed with other PUs rather than being a pure waste stream.^{24,25} Reprocessing methods that enable the properties of the product PUs to be tuned to suit particular targets, and that tolerate polymer blends, are necessary for successful mixed waste reprocessing.

While waste streams are typically mixed, blends of waste are generally incompatible due to phase segregation of different polymer structures.²⁶ Linear polymers are sometimes compatibilized by introducing block copolymers²⁷⁻³⁰ or by using reactive interchange to produce block copolymers in situ.³¹⁻³⁴ The compatibilization of CANs might produce miscible blends because the rearranged chemical crosslinks will preclude phase separation.³⁵⁻³⁸ However, this concept has not previously been achieved. For example, Zhang and coworkers compression molded two polyester CANs, one rigid and one soft, in the presence of Zn(OAc)₂ as a transesterification catalyst.³⁹ Dynamic mechanical thermal analysis (DMTA) showed that the resulting compression molded materials were phase separated, as evidenced by the observation of two glass-transition temperatures and reduced mechanical properties. Previous work in blending PU by Rabnawaz and co-workers showed that PUs can be mixed and extruded in the presence of excess diols and zinc 2-ethylhexanoate to allow for reprocessability via partial depolymerization.⁴⁰ The mechanical properties are inherently altered by this process because the new diols that enable extrusion are incorporated into the structure. The mechanical properties are weakened through the inclusion of excess diols at around 14% composition by weight.

The presently disclosed technology overcomes such issues. One aspect of the technology provides for methods for reprocessing a PU composition. The method may comprise introducing the PU composition into a compounding device, heating the PU composition to an effective bond-exchange temperature, and compounding the PU composition for an effective bond-exchange time. The PU composition may comprise two or more network polymers and an effective amount of a PU exchange catalyst permeated within the polyurethane composition or one or more network polymers. The two or more network polymers each comprise a dynamic network formed from an isocyanate constitutional unit and a second constitutional unit having a hydroxyl group capable of reacting with an isocyanate group of the isocyanate constitutional unit to form a urethane bond. Some or all of the two or more network polymers may be mechanically processed prior to introduction of the PU into the compounding device or preparation of the PU composition.

Suitably the PU composition may comprise two or more different network polymers having different mechanical properties. For example, the PU composition may have two network polymers that may be characterized as soft and rigid. The PU composition may comprise more than two different network polymers, such as 3, 4, 5, 6, 7, 8, 9, or 10. The PU composition can comprise a plurality of different network polymers from a mix waste stream.

Mechanical or thermal properties of compounded PU composition may be tuned by selecting the relative percentages of each of the two or more network polymers. For example, the relative percentages of the two or more network polymers may be determined by the weight percent (wt %) of each network polymer. Other measures of the relative percentages of the two or more network polymers may also be used, e.g., mole percent (mol %). The relative percentage of each of the network polymers may vary over a wide range. For example with a PU composition comprising two different network polymers, the wt % may be between about 5 wt % to about 95 wt %, e.g, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, or any wt % therebetween.

The compounded PU composition may be recovered and further processed. One or more additional network polymers may be introduced with the compounded PU composition into a second compounding device. The second compounding device may be the same compounding device that compounded the PU composition, or it may be a different compounding device. The one or more additional network polymers and the compound PU composition may be heated to a second effective bond-exchange temperature and compounded for a second effective bond-exchange time. The second bond-exchange temperature may be the same bond-exchange temperature at which the PU composition was compounded, or it may be different. The second bond-exchange time may be the same duration as the bond-exchange time that the PU composition was compounded, or it may be different. Additional PU exchange catalyst may also be introduced.

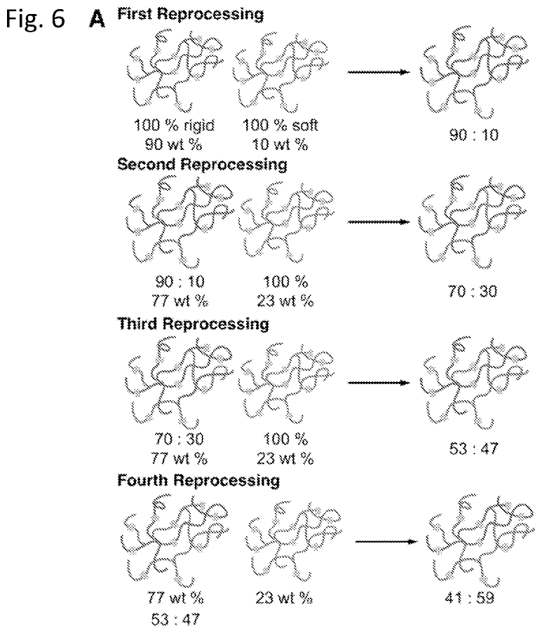

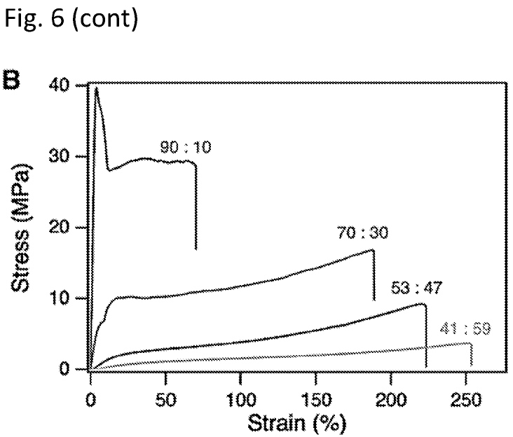

A PU composition and additional network polymers may be repeated compounded. The selection of the additional network polymer may be chosen to obtain a desired mechanical or thermal property. For example, PU compositions may be reprocessed multiple times to tune mechanical properties from rigid to soft with each reprocessing step by introducing a soft network polymer with each step (FIG. 6A). Similarly, PU compositions may be reprocessed multiple times to tune mechanical properties from soft to rigid with each reprocessing step by introducing a rigid network polymer with each step. Alternatively, a soft or rigid network polymer may be introduced in different reprocessing steps to tune the mechanical properties until a desired property is reached.

In some embodiments, the method may comprise an additional step where the compounded PU composition is tested to determine an as-compounded mechanical or thermal property. Based on the determined property, one or more additional network polymers may be selected to obtain a desired mechanical or thermal property. For example, the Young's modulus of the compounded PU composition may be determined, and the one or more additional network polymers may be chosen to increase or decrease the Young's modulus of the compounded composition in a reprocessing step.

Methods for preparing a blended reprocessed PU network is provided. The method may comprise extruding, with a twin-screw extruder, a blend of different PUs in the presence of a carbamate exchange catalyst. Within the twin-screw extruder, the blend of different PUs may be heated to an effective bond-exchange temperature for an effective bond-exchange time. The extrudate by be recovered and extruded with a second PU in a further reprocessing step. In some embodiments, the polyurethanes comprise powdered polyurethanes.

The Examples demonstrate blending and compatibilization of multiple PU CANs in the presence of a polyurethane exchange catalyst can produce reprocessed CANs with tunable mechanical properties. Compounding, such as through extrusion with a twin-screw extruder, produced homogenous and fully compatibilized reprocessed blends, as demonstrated by their mechanical properties which are similar to that of newly synthesized materials. Reprocessing mixed CAN samples with a compounding device more effectively reprocessed mixed compression molded samples as demonstrated by their mechanical properties and distinct polymer domains observed by AFM. The tunability of the material properties were shown through altering the feed composition of rigid and soft CANs, which provided blended solids with properties ranging from soft to elastomeric to rigid. The tunability of the extruded materials was then demonstrated through multiple reprocessing cycles with the addition of more starting polyurethane film alter the resulting material from rigid to soft. These results demonstrate that two or more thermoset networks can be blended to tune the mechanical properties of the resulting material while also compatibilizing otherwise incompatible waste streams.

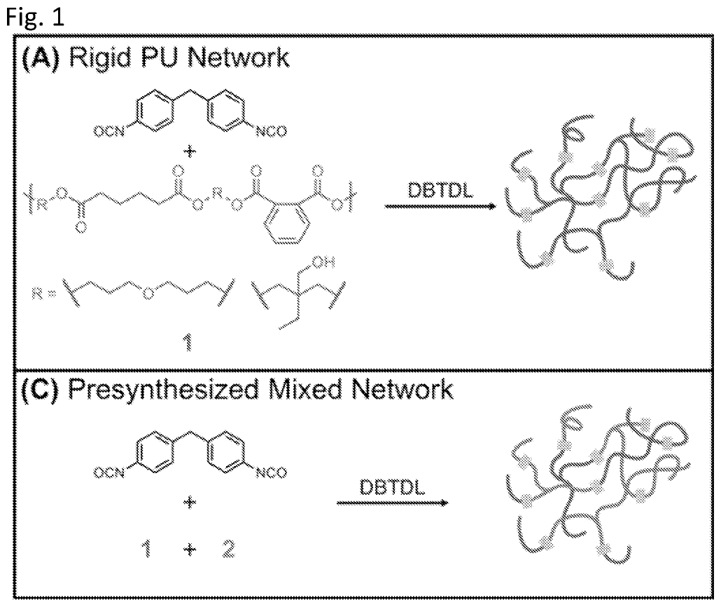

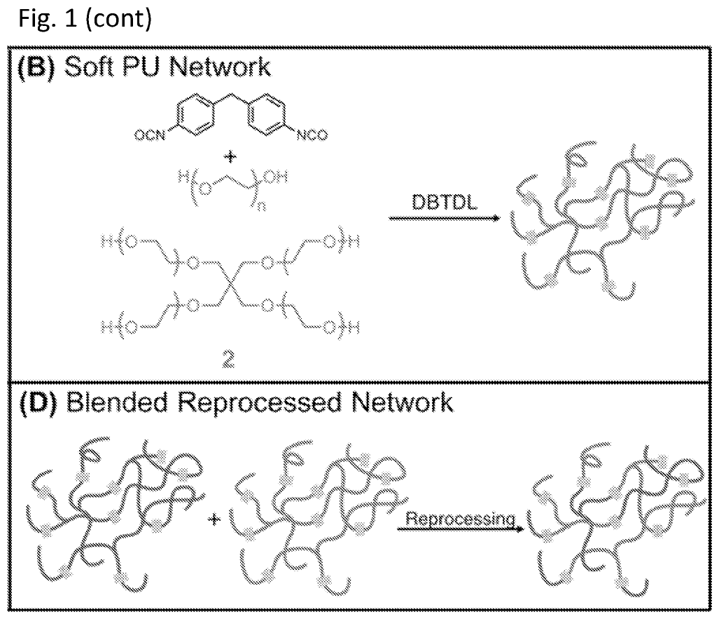

As demonstrated in the Examples, PUs with different polyol components were selected as rigid or soft PU networks to evaluate their blending and reprocessing (FIG. 1). These PU samples contained 1.5 mol % of DBTDL with respect to their carbamate functional groups to catalyze urethane exchange during reprocessing. Prior to polymerization, both polyols were dried to prevent isocyanate hydrolysis, which leads to urea formation in the network. The polyester PU film had a glass-transition temperature (T_{g}) of 64.3° C. with a tensile stress of 40±4 MPa, a strain at break of 3.6±0.9%, and a Young's modulus of 1.6±0.1 GPa (Tables 1-2). The polyether PU film exhibited a 72 of 10.7° C., tensile stress of 2.0±0.1 MPa, a strain at break of 430±40%, and a Young's modulus of 2.0±0.1 MPa.

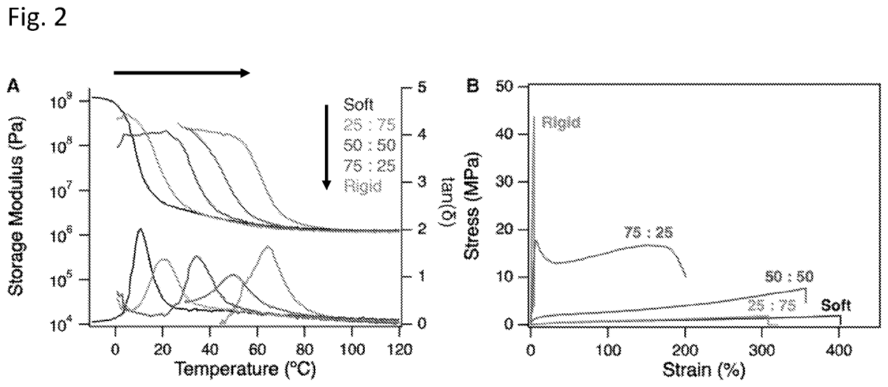

The polyols were mixed in various ratios and then polymerized to give mixed composition PU networks that had not been reprocessed. The thermal and mechanical properties of these polymer blends were characterized and used to benchmark those of mixed composition samples prepared by reprocessing mixtures of the pure polymer networks (FIG. 1C). Dynamic mechanical thermal analysis (DMTA) of these pre-synthesized mixtures shows that the T_{g} values, as determined by the temperature of maximum of the tan (8) response, follow a linear trend with composition (FIG. 2A, Table 3). Each sample exhibited a similar plateau of the storage modulus at 120° C., indicating that the pure polymers and synthesized blends all have similar crosslink densities. Tensile plots show that the blends have high strains at break (>200%), at 75% incorporation of the rigid polyol (FIG. 2B). The tensile stress increases with increasing rigid content from 2.1±0.3 MPa for the 25:75 rigid:soft blend to 17.9±0.1 MPa for the 75:25 blend and the strain at break decreases accordingly from 320±10% to 210±10% (Table 4). These as-synthesized blends demonstrate how the mechanical properties can be greatly enhanced through blending of the two chemically distinct PU materials. These properties are quantitative benchmarks for evaluating mixed-composition PU networks obtained by reprocessing mixtures of the two PU homopolymers.

Compounding, such as by twin-screw extrusion, could be beneficial for mixing two PU films efficiently during reprocessing (FIG. 1D). Mixtures of the two as-synthesized rigid and soft films were reprocessed using twin-screw extrusion at 200° C. to yield reprocessed blends of varying hard and soft compositions. The screws were co-rotating at 150 rpm under a stream of N₂ to prevent oxidation. The extruded blends were first compared to PU blends reprocessed using compression molding, which involved heating the two PU polymers in a rectangular mold for one hour at 160° C. under high pressure. Compression molding at higher temperatures led to bubbling in the samples, which made the samples untestable by tensile testing. Following this procedure, the compression molded materials were heated at 90° C. for 2 days in a vacuum oven.

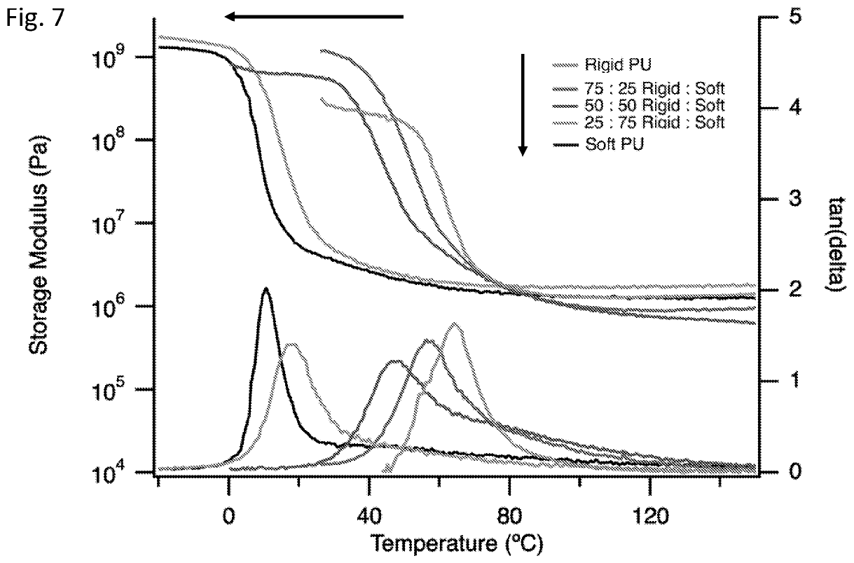

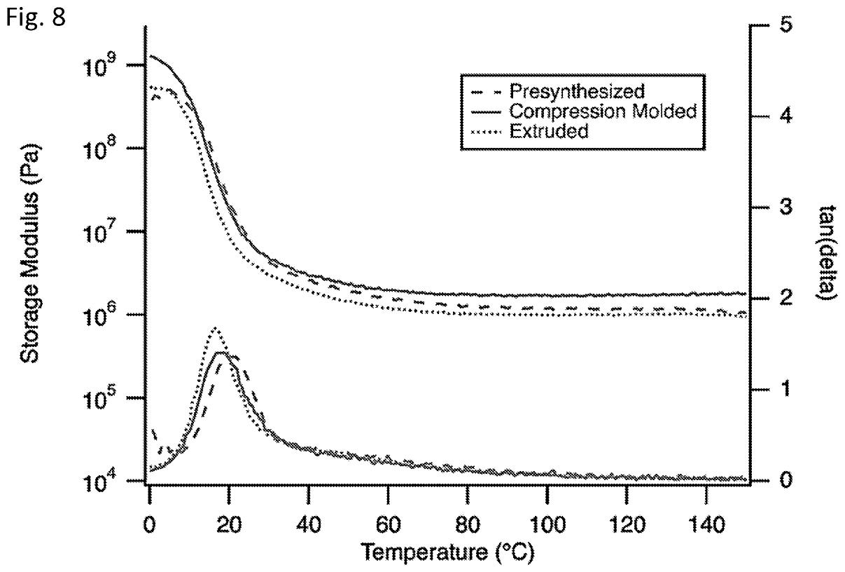

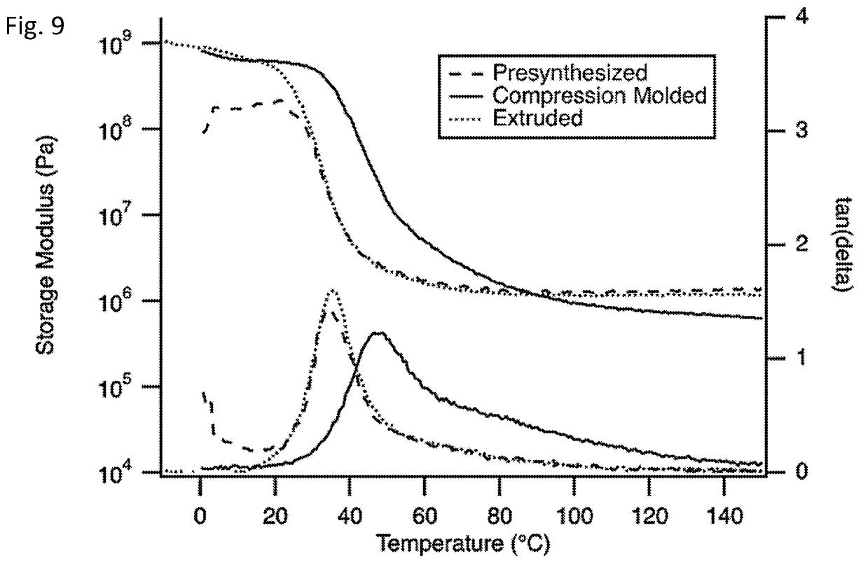

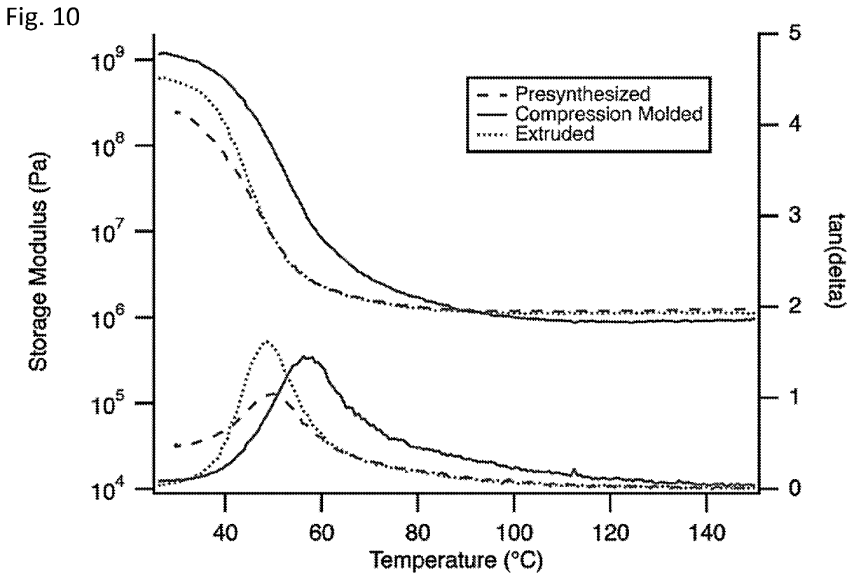

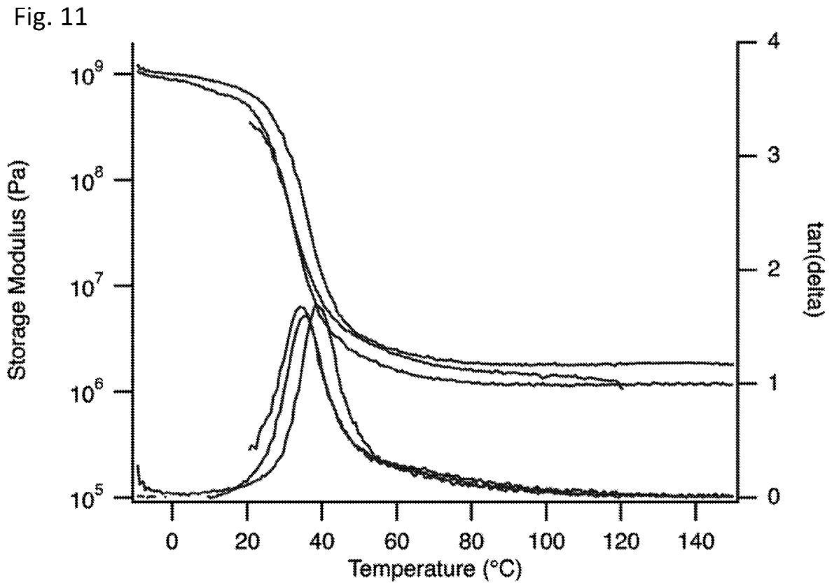

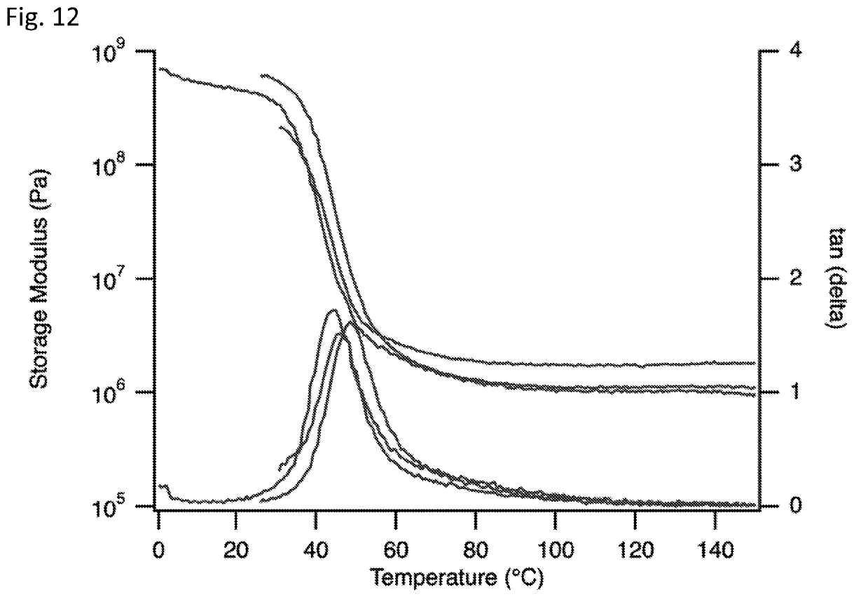

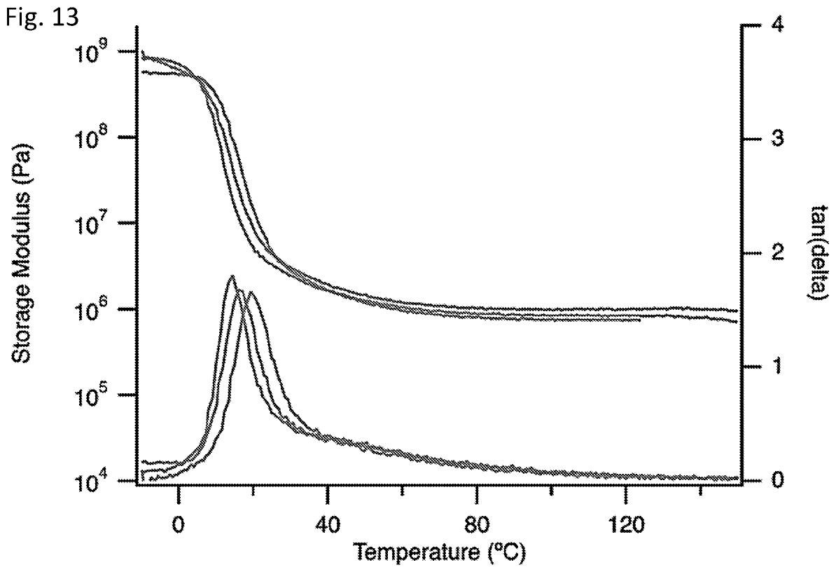

DMTA showed that reprocessing by extrusion gave T_{g} values and storage moduli similar to newly synthesized blends, whereas compression molding gave inferior properties that implicated inefficient mixing. The compression molded materials seemed homogenous based on the single tan (8) response by DMTA (FIG. 7) yet their plots of storage modulus as a function of temperature showed different T_{g} values than those for the as-synthesized blends and extruded materials, along with variable crosslinking densities (FIGS. 8-10). The T_{g} values for the more rigid samples were higher than the expected values based upon the extruded blends of the same composition (Table 5), potentially due to the feed composition not matching the composition after compression molding. In contrast, the rubbery plateau of the storage moduli of extruded materials was similar to the as-synthesized networks, indicating that the extruded samples retain most of their crosslink density during reprocessing. DMTA taken at different sections of the extrudate show that the T_{g} did not vary during the extrusion, indicating that the composition remains constant throughout the extrusion (FIGS. 11-13). The crosslinking density of the extruded blends also matches well with the expected based on the storage moduli at 120° C. of the as synthesized rigid and soft PUs. In contrast to compression molding, the DMTA responses for polymer mixtures reprocessed by twin-screw extrusion are similar to polymers synthesized directly from polyol mixtures.

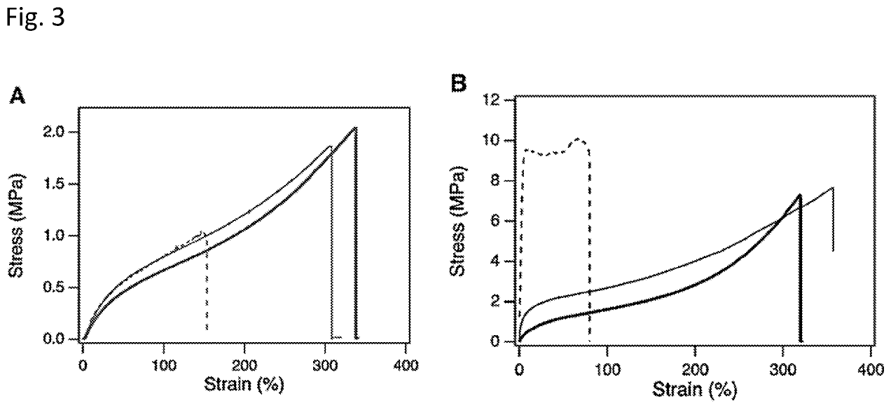

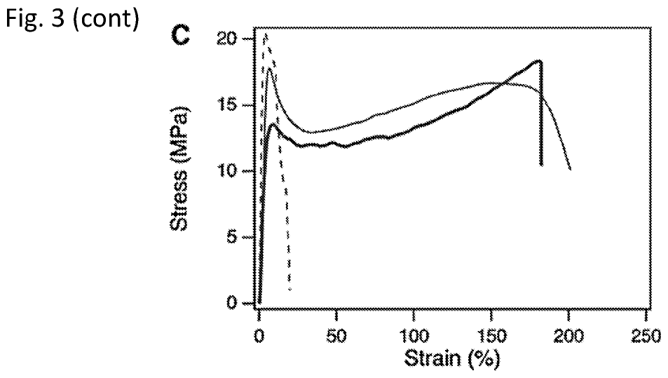

Reprocessing by extrusion gave materials of similar quality to as-synthesized blends, whereas compression molding produced polymers with inferior mechanical properties (FIG. 3). Tensile tests of the extruded materials showed similar stress-strain responses to the as-synthesized blended materials of the same composition, again suggesting efficient reprocessing and mixing during extrusion. The 25:75 rigid:soft extruded blend, with a T_{g} of 19.3° C., had a Young's modulus of 1.1±0.2 MPa, an average strain at break of 310±30%, and a tensile stress of 1.7±0.4 MPa (FIG. 3A, Table 6). The corresponding polymer reprocessed by compression molding had a tensile stress of 0.97 MPa, a strain at break of 153%, and a Young's modulus of 2 MPa (Table 7). The 50:50 extruded blend, with a T_{g} of 35.8° C., had a Young's modulus of 5.3±0.4 MPa, a tensile stress of 7.2±0.2 MPa, and a strain at break of 300±20% (FIG. 3B), which varies drastically from the compression molded 50:50 blend. The compression molded sample had with a T_{g} of 47.4° C., tensile stress of 10.1 MPa, strain at break of 79.7%, and Young's modulus of 260 MPa. The 75:25 extruded blend also had dramatically different mechanical properties from the compression molded blend, in addition to a difference in T_{g} of 8.3° C. with the extruded blend having a T_{g} of 48.5° C. and the compression molded blend having a T_{g} of 56.8° C. The tensile data shows that the extruded blend had a tensile stress of 16±3 MPa, a strain at break of 170±10%, and a Young's modulus of 170±40 MPa, in contrast to the compression molded blend which showed 34.4 MPa, 10.4%, and 1300 MPa, respectively (FIG. 3C). The extruded samples more closely matched the desired mechanical properties found in the as-synthesized blends. Comparison of the tensile data for the three types of PU blending shows that using extrusion as the reprocessing method yields materials with higher quality mechanical properties than compression molding and that the feed composition more closely matches the resulting compositions of the reprocessed materials.

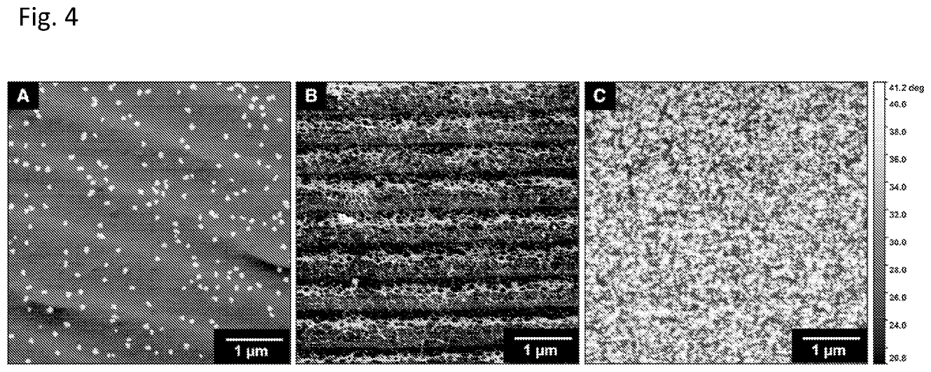

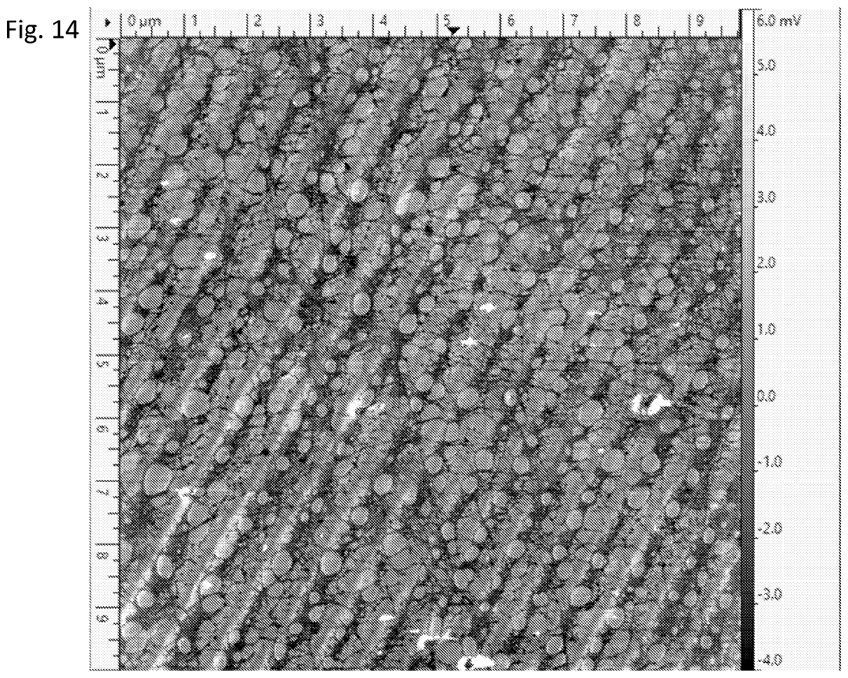

Atomic-force microscopy (AFM) analysis of microtomed cross-sections of the compression molded, extruded, and as-synthesized samples also suggests that extruded samples are more homogenously mixed than compression molded samples (FIG. 4). AFM phase imaging shows that the 50:50 compression molded blend has isolated less dissipative domains within a matrix of more dissipative material, suggesting that the compression molded material is phase separated (FIG. 4A). Also, the amount of each domain does not match with the expected based on the feed composition, which would correspond to the increased T& than the expected. AFM phase imaging of the 50:50 extruded blend shows that the extruded material has a different microstructure than the compression molded material (FIG. 4B). The extruded material appears better mixed, as it lacks isolated domains. Indeed, the extruded samples approach the uniform images of the as-synthesized blends that appear molecularly mixed (FIG. 4C). AFM friction force imaging in contact mode also suggests this microstructure (FIG. 14). Overall, AFM phase imaging suggests that the compression molded samples are phase separated and extrusion gives more well-mixed reprocessed samples.

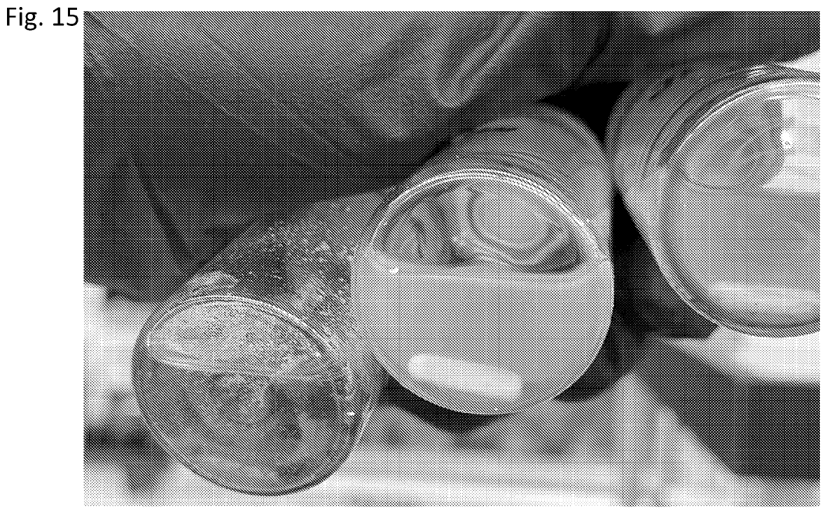

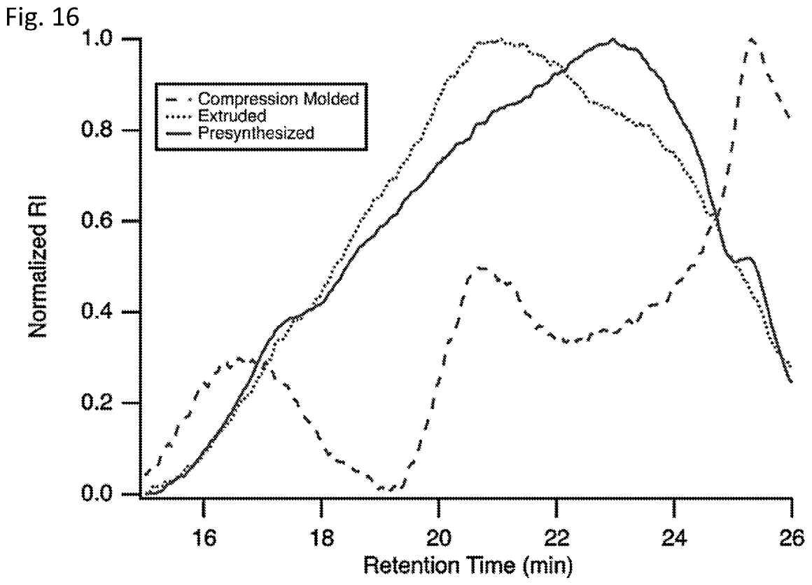

The degree of mixing of the reprocessed compression molded and extruded samples was evaluated chemically by selectively hydrolyzing the polyester polyol, while leaving polyether PU intact. The polyester PU networks were hydrolyzed using hydrochloric acid and water to yield a soluble oil, which was characterized by gel-permeation chromatography (GPC), while the as-synthesized polyether PU did not hydrolyze under these conditions and the resulting material had a gel fraction of 96%. When the 50:50 blends were subjected to these conditions for 1 d at room temperature, the as-synthesized and extruded blends yielded an oil. In contrast, hydrolysis of the polyester polyol within the compression molded material yielded insoluble particles (FIG. 15). GPC analysis of the compression molded byproducts shows evidence for higher molecular weight species compared to the extruded and as-synthesized blends (FIG. 16). This finding is also consistent with the compression molded material being more phase separated. GPC of the extruded 50:50 blend suggested, based on the molecular weight of the resulting polyether PU blocks, that this blending method is in between that of compression molding and mixing the polyols pre-synthesis, since the peaks span a large amount of retention times but are lower molecular weight as the compression molded sample

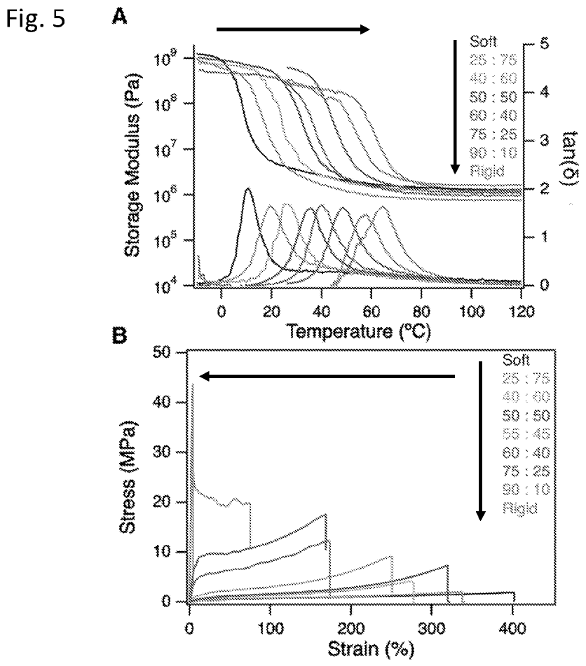

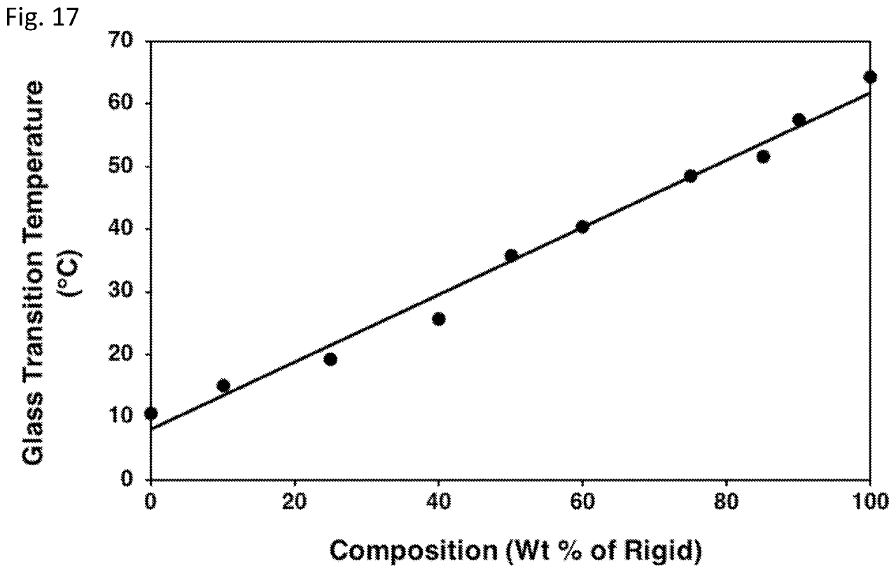

Multiple mixed PUs were reprocessed by extrusion to determine how the composition of the rigid and soft PU feedstocks would influence the T_{g} and the mechanical properties. Both T_{g} and the tensile properties of each PU sample were highly tunable based on the rigid:soft composition in samples reprocessed by extrusion (FIG. 5). Each of the mixed rigid:soft PUs had gel fractions higher than 80%, indicating that their crosslinks were largely retained throughout the extrusion process (Table 8). DMTA was also consistent with this conclusion, as each sample showed rubbery plateau moduli within 20% of one another, indicating similar crosslink densities. The T_{g} of each sample followed a linear trend that was proportional to the rigid PU content (FIG. 5A, Table 9), as determined by plotting the peak of each tan (8) against weight percent of rigid PU (FIG. 17). This simple relationship enables precise tuning of the T_{g} by varying the PU composition, which may prove valuable for targeting specific target applications for reprocessed PUs or adjusting a future recycling process to ensure consistent properties from variable waste streams. The linear trend of these transition temperatures is similar to the T_{g} trend seen in miscible thermoplastic polymer blends.⁴¹

The tensile properties of the reprocessed PU series indicate that these materials can be tuned from rigid to elastomeric to soft polymer networks (FIG. 5B, Table 10). The rigid PU blends had compositions ranging from 90:10 to 60:40 with tensile stresses ranging from 33±9 MPa to 13±1 MPa, strains at break between 73±4% and 170±10%, and Young's moduli ranging from 1100±30 MPa to 110±30 MPa. Blends with rigid:soft compositions between 55:45 to 50:50 were elastomeric with tensile stresses of 9.4±0.3 MPa and 7.2±0.2 MPa, strains at break of 240=10% and 300±20%, and Young's moduli of 12±1 MPa and 5.3±0.4 MPa. Extruded PU blends with rigid contents below 40 wt % were soft crosslinked networks with tensile stresses below 3.8±0.5 MPa, strains at break between 290±20% and 310±30%, and Young's moduli below 2.2±0.7 MPa. The mechanical properties of these blends demonstrate how varying the composition over approximately a 5-10 weight percent range can fine-tune the mechanical properties of the sample while retaining its overall mechanical character (e.g., rigid, elastomeric, etc.). These observations provide a high degree of control over the resulting material's properties based on feed composition, which will benefit the overall circularity of PUs reprocessed using this approach.

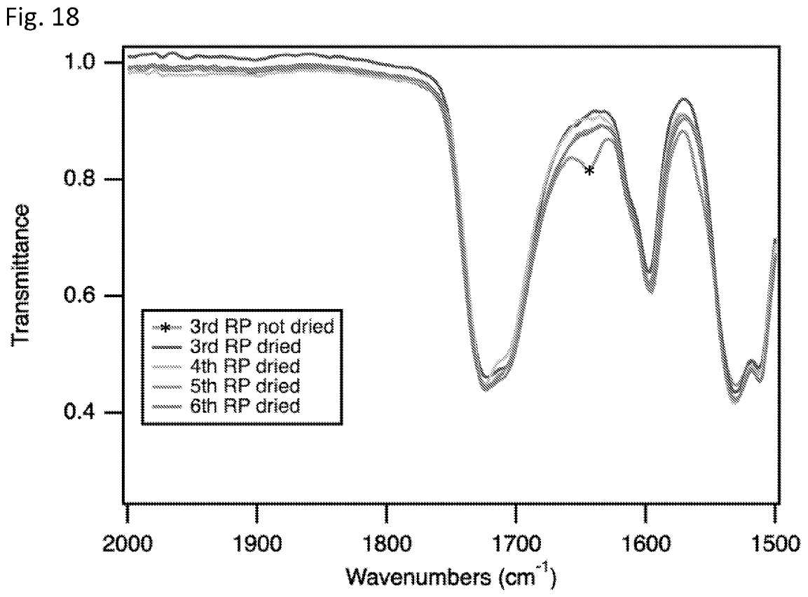

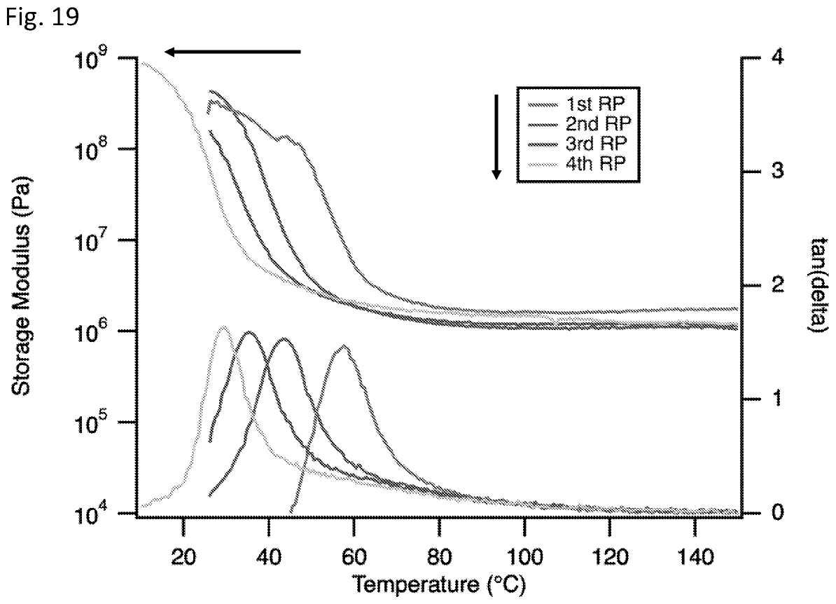

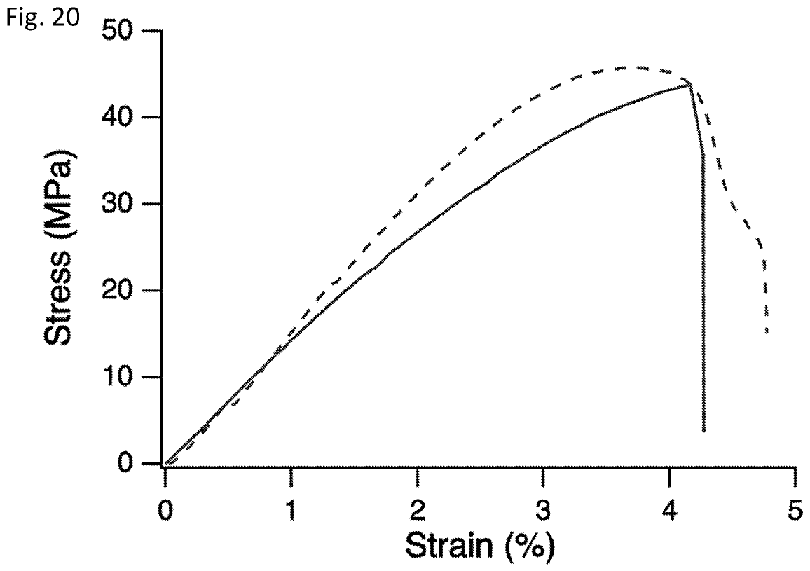

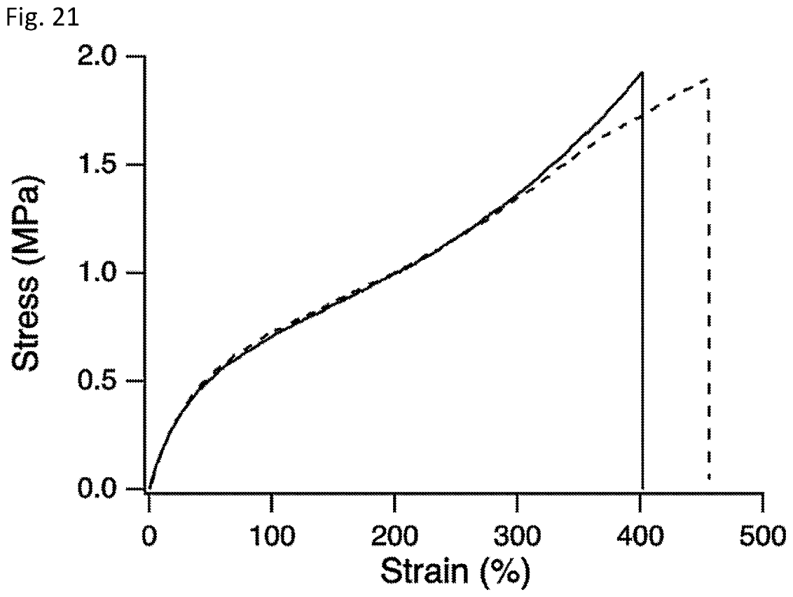

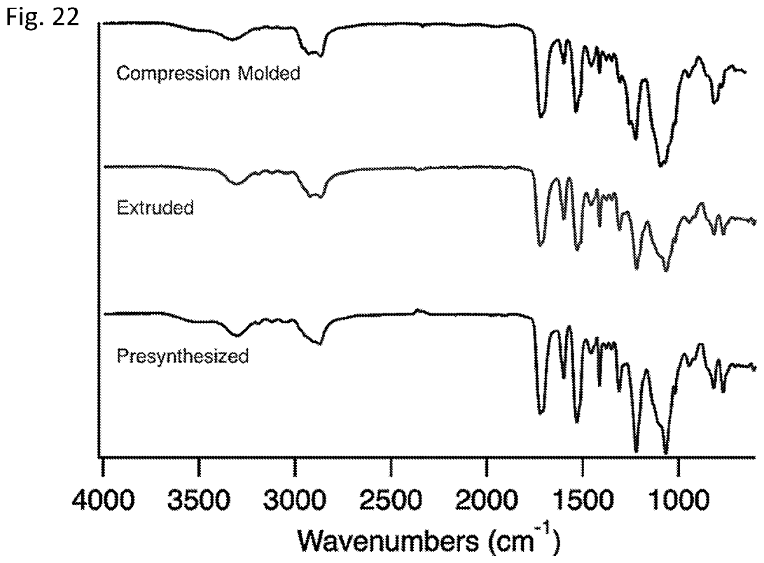

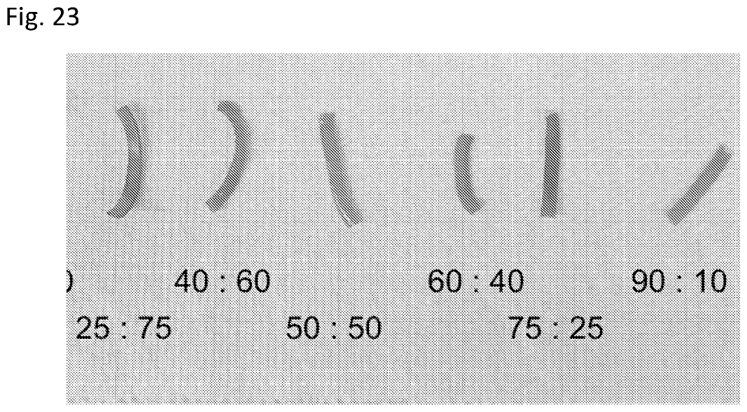

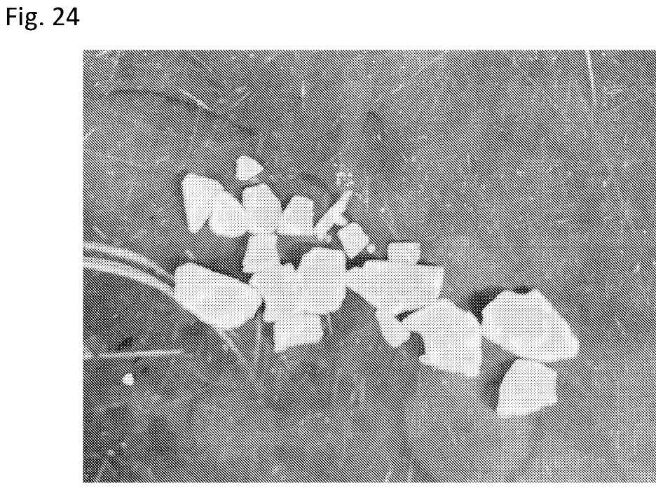

To demonstrate the effectiveness and efficiency of twin-screw extrusion as an iterative reprocessing method, the blends were reprocessed multiple times while adding additional newly synthesized PU to tune the mechanical properties from rigid to soft with each reprocessing step (FIG. 6A). The starting blend composition was reprocessed once to yield a 90:10 rigid:soft material. 23 wt % of newly synthesized soft PU was added during the second reprocessing cycle, which provided a film with a resulting composition of 69:31 rigid:soft. This process was repeated twice, each time adding additional newly synthesized soft PUs to yield films with compositions of 53:47 and 41:59 rigid:soft, respectively. Prior to each reprocessing step, we found it important to dry films overnight at 90° C. in a vacuum oven prior to extrusion to remove water absorbed due to the hydrophilicity of the polyols. Films that were not dried rigorously prior to reprocessing showed inferior tensile properties and evidence of urea formation in their infrared spectra (FIG. 18). These observations are consistent with a crosslink exchange process in which carbamates transiently dissociate to isocyanates and alcohols at elevated temperatures, which reform new carbamates in the compatibilized materials. The presence of water during this process can decarboxylate isocyanates to amines, which undergo further nucleophilic addition reactions to produce ureas. However, water sensitivity during PU formation is well known in its manufacture⁴², and water management is likely to be required in PUs reprocessed using this or related approaches. DMTA of the four iteratively reprocessed polymers shows that the films remain homogenous after each step with the magnitude and breadth of the tan (δ) response mostly unchanged after each reprocessing cycle (FIG. 19). The DMTA plots also show that there is no loss in crosslinking density, even after four consecutive extrusions. Furthermore, the T_{g} for each blend was consistent with the linear composition trend measured for singly reprocessed PUs of different compositions. For each of the four consecutively reprocessed samples, the predicted T_{g} values were within 2° C. of the values expected based on their rigid:soft composition (Table 11). The tensile properties of the resulting multiply reprocessed blends were similar to the mechanical properties of blends with similar compositions that were reprocessed only once. The second reprocessing cycle yielded a film composed of 69 weight percent of rigid had a T_{g} of 43.4° C., a tensile stress of 17.4±0.9 MPa, a strain at break of 200±30%, and a Young's modulus of 170±20 MPa (FIGS. 6B, Table 12), which matches closely with the mechanical properties of the 75:25 blend. For the third reprocessing cycle, the resulting material had a T_{g} of 35.5° C. and a composition of 53:47. The mechanical properties for this triply reprocessed material matched the properties of the 55:45 blend with a tensile stress of 9.32±0.08 MPa, a strain at break of 230±10%, and a Young's modulus of 12±1 MPa. The fourth reprocessing cycle yielded a material with a resulting composition of 41:59 with a T_{g} of 29.5° C. The mechanical properties of this extruded film were a tensile stress of 3.5±0.3 MPa, a strain at break of 250±20%, and a Young's modulus of 2.8±0.3 MPa, which were similar to the 40:60 singly reprocessed blend. All of these multiply reprocessed materials exhibited toughness values that were greater than 90% of the toughness of the singly extruded blends of similar compositions, further indicating the efficiency of this blending method (Table 13). This reprocessing experiment tuning the composition and material properties from rigid to elastomer to soft demonstrates how this reprocessing and blending method again can be predictable and mimics a potential mixed waste feedstock in which already reprocessed materials are mixed with new waste streams.

This work establishes that mixtures of crosslinked PU networks can be reprocessed and simultaneously compatibilized by co-extruding the polymers in the presence of a carbamate exchange catalyst. Use of DBTDL as a carbamate exchange catalyst is being phased out due to the toxicity of tin and future studies into greener alternatives can address these concerns. This process mixes the polymers and rearranges their covalent bonds efficiently, such that the reprocessed blends have similar thermal and mechanical properties as compared to as-synthesized polymer networks containing mixtures of the two polyol components. Extrusion was superior in this regard compared to reprocessing by compression molding, which produced materials with inferior properties and inhomogeneous structures. These findings show great potential for continuous recycling and repurposing of PU waste streams to produce polymers of equal or higher value. With this method, unknown mixed PU waste streams might be managed actively to maintain desired properties in the recycled product. More broadly, this approach might enable specific PU waste streams to be intentionally combined to upcycle these materials into higher value applications.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used. “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCES

(1) Sonnenschein, M. F. Polyurethanes: Science, Technology, Markets, and Trends; Wiley: Hoboken, NJ, 2015.
(2) Szycher, M. Szycher's Handbook of Polyurethanes, 2nd ed.; Taylor & Francis, 2012.
(3) Geyer, R.; Jambeck, J. R.; Law, K. L. Production, Use, and Fate of All Plastics Ever Made. Sci. Adv. 2017, 3 (7), e1700782.
(4) Zia, K. M.; Bhatti, H. N.; Ahmad Bhatti, I. Methods for Polyurethane and Polyurethane Composites, Recycling and Recovery: A Review. React. Funct. Polym. 2007, 67 (8), 675-692.
(5) Borda, J.; Pásztor, G.; Zsuga, M. Glycolysis of Polyurethane Foams and Elastomers. Polym. Degrad. Stab. 2000, 68 (3), 419-422.
(6) Vollmer, I.; Jenks, M. J. F.; Roelands, M. C. P.; White, R. J.; van Harmelen, T.; de Wild, P.; van der Laan, G. P.; Meirer, F.; Keurentjes, J. T. F.; Weckhuysen, B. M. Beyond Mechanical Recycling: Giving New Life to Plastic Waste. Angew. Chemie-Int. Ed. 2020, 59 (36), 15402-15423.
(7) You, K. K.; Durocher, D. T.; Kierkus, P. C.; Fishback, T. L. Chemical Recycling of Polyurethanes and Applications for the Recyclates. J. Cell. Plast. 1998, 34 (3), 261-271.
(8) Matuszak, M. L.; Frisch, K. C.; Reegen, S. L. Hydrolysis of Linear Polyurethanes and Model Monocarbamates. J Polym Sci Part A-1 Polym Chem 1973, 11 (7), 1683-1690.
(9) Mahoney, L. R.; Weiner, S. A.; Ferris, F. C. Hydrolysis of Polyurethane Foam Waste. Environ. Sci. Technol. 1974, 8 (2), 135-139.
(10) Simón, D.; Borreguero, A. M.; de Lucas, A.; Rodríguez, J. F. Recycling of Polyurethanes from Laboratory to Industry, a Journey towards the Sustainability. Waste Manag. 2018, 76, 147-171.
(11) Helling, R. K.; Russell, D. A. Use of Life Cycle Assessment to Characterize the Environmental Impacts of Polyol Production Options. Green Chem. 2009, 11 (3), 380-38.
(12) Maisonneuve, L.; Lamarzelle, O.; Rix, E.; Grau, E.; Cramail, H. Isocyanate-Free Routes to Polyurethanes and Poly(Hydroxy Urethane) S. Chem. Rev. 2015, 115 (22), 12407-12439.
(13) Rokicki, G.; Parzuchowski, P. G.; Mazurek, M. Non-Isocyanate Polyurethanes: Synthesis, Properties, and Applications. Polym. Adv. Technol. 2015, 26 (7), 707-761.
(14) Denissen, W.; Winne, J. M.; Du Prez, F. E. Vitrimers: Permanent Organic Networks with Glass-like Fluidity. Chem. Sci. 2016, 7 (1), 30-38.
(15) Fortman, D. J.; Brutman, J. P.; De Hoe, G. X.; Snyder, R. L.; Dichtel, W. R.; Hillmyer, M. A. Approaches to Sustainable and Continually Recyclable Cross-Linked Polymers. ACS Sustain. Chem. Eng. 2018, 6 (9), 11145-11159.
(16) Fortman, D. J.; Brutman, J. P.; Cramer, C. J.; Hillmyer, M. A.; Dichtel, W. R. Mechanically Activated, Catalyst-Free Polyhydroxyurethane Vitrimers. J. Am. Chem. Soc. 2015, 137 (44), 14019-14022.
(17) Montarnal, D.; Capelot, M.; Tournilhac, F.; Leibler, L. Silica-like Malleable Materials from Permanent Organic Networks. Science (80-.). 2011, 334 (6058), 965-968.
(18) Kloxin, C. J.; Scott, T. F.; Adzima, B. J.; Bowman, C. N. Covalent Adaptable Networks (CANs): A Unique Paradigm in Cross-Linked Polymers. Macromolecules 2010, 43 (6), 2643-2653.
(19) Swartz, J. L.; Li, R. L.; Dichtel, W. R. Incorporating Functionalized Cellulose to Increase the Toughness of Covalent Adaptable Networks. ACS Appl. Mater. Interfaces 2020, 12 (39), 44110-44116.
(20) Fortman, D. J.; Sheppard, D. T.; Dichtel, W. R. Reprocessing Cross-Linked Polyurethanes by Catalyzing Carbamate Exchange. Macromolecules 2019, 52 (16), 6330-6335.
(21) Chen, Z.; Sun, Y. C.; Wang, J.; Qi, H. J.; Wang, T.; Naguib, H. E. Flexible, Reconfigurable, and Self-Healing TPU/Vitrimer Polymer Blend with Copolymerization Triggered by Bond Exchange Reaction. ACS Appl. Mater. Interfaces 2020, 12 (7), 8740-8750.
(22) Wang, S.; Ma, S.; Qiu, J.; Tian, A.; Li, Q.; Xu, X.; Wang, B.; Lu, N.; Liu, Y.; Zhu, J. Upcycling of Post-Consumer Polyolefin Plastics to Covalent Adaptable Networks via in Situ Continuous Extrusion Cross-Linking. Green Chem. 2021, 2931-2937.
(23) Sheppard, D. T.; Jin, K.; Hamachi, L. S.; Dean, W.; Fortman, D. J.; Fortman, D. J.; Ellison, C. J.; Dichtel, W. R. Reprocessing Postconsumer Polyurethane Foam Using Carbamate Exchange Catalysis and Twin-Screw Extrusion. ACS Cent. Sci. 2020, 6 (6), 921-927.
(24) Ragaert, K.; Huysveld, S.; Vyncke, G.; Hubo, S.; Veelaert, L.; Dewulf, J.; Du Bois, E. Design from Recycling: A Complex Mixed Plastic Waste Case Study. Resour. Conserv. Recycl. 2020, 155 (March 2019), 104646.
(25) Deng, Y.; Dewil, R.; Appels, L.; Ansart, R.; Baeyens, J.; Kang, Q. Reviewing the Thermo-Chemical Recycling of Waste Polyurethane Foam. J. Environ. Manage. 2021, 278 (P1), 111527.
(26) Snyder, H. L.; Meakin, P.; Reich, S. Dynamical Aspects of Phase Separation in Polymer Blends. Macromolecules 1983, 16 (5), 757-762.
(27) Eagan, J. M.; Xu, J.; Di Girolamo, R.; Thurber, C. M.; Macosko, C. W.; La Pointe, A. M.; Bates, F. S.; Coates, G. W. Combining Polyethylene and Polypropylene: Enhanced Performance with PE/IPP Multiblock Polymers. Science (80-.). 2017, 355 (6327), 814-816.
(28) Bates, C. M.; Bates, F. S. 50th Anniversary Perspective: Block Polymers-Pure Potential. Macromolecules 2017, 50 (1), 3-22.
(29) Klimovica, K.; Pan, S.; Lin, T.-W.; Peng, X.; Ellison, C. J.; Lapointe, A. M.; Bates, F. S.; Coates, G. W. Compatibilization of IPP/HDPE Blends with PE-g-IPP Graft Copolymers. ACS Macro Lett. 2020, 9 (8), 1161-1166.
(30) Yang, Z.; Peng, H.; Wang, W.; Liu, T. Crystallization Behavior of Poly(ε-Caprolactone)/Layered Double Hydroxide Nanocomposites. J. Appl. Polym. Sci. 2010, 116 (5), 2658-2667.
(31) Yin, Z.; Koulic, C.; Pagnoulle, C.; Jerome, R. Reactive Blending of Functional PS and PMMA: Interfacial Behavior of in Situ Formed Graft Copolymers. Macromolecules 2001, 34 (15), 5132-5139.
(32) Sailer, C.; Handge, U. A. Reactive Blending of Polyamide 6 and Styrene-Acrylonitrile Copolymer: Influence of Blend Composition and Compatibilizer Concentration on Morphology and Rheology. Macromolecules 2008, 41 (12), 4258-4267.
(33) Todd, A. D.; Mceneany, R. J.; Topolkaraev, V. A.; Macosko, C. W.; Hillmyer, M. A. Reactive Compatibilization of Poly(Ethylene Terephthalate) and High-Density Polyethylene Using Amino-Telechelic Polyethylene. Macromolecules 2016, 49 (23), 8988-8994.
(34) Hu, L.; Vuillaume, P. Y. Chapter 7-Reactive Compatibilization of Polymer Blends by Coupling Agents and Interchange Catalysts; A. R., A., Thomas, S. B. T.-C. of P. B., Eds.; Elsevier, 2020; pp 205-248.
(35) Kim, H. J.; Peng, X.; Shin, Y.; Hillmyer, M. A.; Ellison, C. J. Blend Miscibility of Poly(Ethylene Terephthalate) and Aromatic Polyesters from Salicylic Acid. J. Phys. Chem. B 2021, 125 (1), 450-460.
(36) Fortman, D. J.; Snyder, R. L.; Sheppard, D. T.; Dichtel, W. R. Rapidly Reprocessable Cross-Linked Polyhydroxyurethanes Based on Disulfide Exchange. ACS Macro Lett. 2018, 7 (10), 1226-1231.
(37) Chen, X.; Hu, S.; Li, L.; Torkelson, J. M. Dynamic Covalent Polyurethane Networks with Excellent Property and Cross-Link Density Recovery after Recycling and Potential for Monomer Recovery. ACS Appl. Polym. Mater. 2020, 2 (5), 2093-2101.
(38) Martin, R.; Rekondo, A.; Ruiz De Luzuriaga, A.; Santamaria, A.; Odriozola, I. Mixing the Immiscible: Blends of Dynamic Polymer Networks. RSC Adv. 2015, 5 (23), 17514-17518.
(39) Zhang, B.; Yuan, C.; Zhang, W.; Dunn, M. L.; Qi, H. J.; Liu, Z.; Yu, K.; Ge, Q. Recycling of Vitrimer Blends with Tunable Thermomechanical Properties. RSC Adv. 2019, 9 (10), 5431-5437.
(40) Khan, A.; Naveed, M.; Rabnawaz, M. Melt-Reprocessing of Mixed Polyurethane Thermosets. Green Chem. 2021.
(41) Aubin, M.; Prud′homme, R. E. Analysis of the Glass Transition Temperature of Miscible Polymer Blends. Macromolecules 1988, 21 (10), 2945-2949.
(42) Dušek, K.; Špirková, M.; Havliček, I. Network Formation of Polyurethanes Due to Side Reactions. Macromolecules 1990, 23 (6), 1774-1781.

### EXAMPLES

### Synthesis of Polyester (Rigid) PU

A vial was charged with poly [trimethylolpropane/di(propylene glycol)-alt-adipic acid/phthalic anhydride], polyol (—OH equiv. 2.5, 7.2 g, 36 mmol). The polyol was dried under high vacuum at 90° C. for 16 h prior to network synthesis. Once dried, the polyol was mixed with antioxidant, tris(nonylphenyl) phosphite (364 mg, 2 wt %) and catalyst, dibutyltin dilaurate (341 mg, 1.5 mol % per isocyanate). To this solution, 4,4′-methylenebis(phenyl isocyanate) (4.5 g, 18 mmol), dissolved in DCM (10 mL) was added and the solution was cast into an aluminum mold and placed under reduced pressure at 90° C. for 2 days.

### Synthesis of Polyether (Soft) PU

A vial was charged with poly(ethylene glycol) (400 g/mol, 5.71 g, 14 mmol) and pentaerythritol ethoxylate (15/4 EO/OH, 1.76 g, 2.2 mmol) and dried under high vacuum at 90° C. for 16 h. The polyols were then mixed with antioxidant, tris(nonylphenyl) phosphite (376 mg, 2 wt %) and catalyst, dibutyltin dilaurate (341 mg, 1.5 mol % per isocyanate). To this, 4,4′-methylenebis(phenyl isocayante) (4.5 g, 18 mmol), dissolved in DCM (10 mL), was added and the resulting solution was cast into an aluminum mold and heated at 90° C. for 2 days under reduced pressure.

### Compression Molding of Mixed PU Blends

Rigid and soft PU films of a certain composition were ground up with a coffee grinder and mixed. The resulting powder was placed into a rectangular mold and subjected to 160° C. for 1 hour. The resulting film was removed from the mold and placed in a vacuum oven at 90° C. for 2 d to fully cure the materials.

### Extrusion of Mixed PU Blends

Rigid and soft PU films of a certain composition were ground up using a coffee grinder and mixed. The twin-screw extruder was heated to 200° C. and put under an N₂ flow and allowed to purge the apparatus. The screws were then rotated at 150 rpm. The mixed PU powder was then fed into the hopper and pushed into the barrel. The resulting rectangular film was cut into films for testing.

### Materials and Methods.

All reagents were purchased from Sigma-Aldrich or Fisher Scientific. All reagents were used without further purification unless otherwise specified. Dimethylformamide (DMF) was purchased from Fisher Scientific and purified using a custom-built alumina-column based solvent purification system. Other solvents were purchased from Fisher Scientific and used without further purification.

Infrared spectra were recorded on a Thermo Nicolet iS10 equipped with a ZnSe ATR attachment. Spectra were uncorrected.

Dynamic mechanical thermal analysis (DMTA) was performed on a TA Instruments RSA-G2 analyzer (New Castle, DE) using rectangular films (ca. 1.0 mm (T)×3 mm (W)×6 mm (L)). The transducer was set to spring mode. The axial force was adjusted to 20 g (sensitivity 1.0 g) before the test to ensure the sample was in tension and not buckling. The minimum axial force was set to 5 g, and a force tracking mode was set such that the axial force was twice the magnitude of the oscillation force during the test. A strain adjust of 30% was set with a minimum strain of 0.05%, a maximum strain of 10%, a minimum force of 1 g and a maximum force of 20 g in order to prevent the sample from going out of the specified strain. A temperature ramp was then performed from −30° C. to 120° C. at a rate of 5° C./min, with an oscillating strain of 0.05% and an angular frequency of 6.28 rad s-1 (1 Hz). The glass transition temperature (T_{g}) was calculated from the maximum value of the loss modulus (E″).

Uniaxial tensile testing was conducted using dog bone shaped tensile bars (ASTM D-1708 1.0 mm (T)×5 mm (W)×25 mm (L) and a gauge length of 16 mm). The samples were aged for at least 48 h at ambient temperatures in a desiccator prior to testing. Tensile measurements were performed on a Sintech 20G tensile tester with 250 gram capacity load cell at ambient temperatures at a uniaxial extension rate of 5 mm/min. Young's modulus (E) values were calculated using the TestWorks software by taking the slope of the stress-strain curve from 0 to 1 N of force applied. Reported values are the averages and standard deviations of at least three replicates.

Atomic Force Microscopy imaging was performed using a Keysight 5500 scanning probe microscope operated in ambient air (RH˜25%) running Picoview 1.20 software. The XYZ piezotube scanner (model 9524) was operated in closed loop X-Y with a Z range of ˜8 μm. Data were collected in both the dynamic (“AC”) and quasistatic (“contact”) modes of operation with a single silicon tip (nominal radius of curvature ˜6 nm) attached to an uncoated rectangular silicon cantilever of nominal spring constant ˜2 N/m (AppNano type FORT probes). Images reported in the main body of the paper were collected in dynamic mode (conventional amplitude-modulation feedback) with cantilever vibrated near its fundamental flexural resonance frequency of 68.95 kHz, to provide height and phase along with error signal (amplitude) images. Imaging scan rates were 0.5-0.75 lines per second at a resolution of 512×512 pixels. The cantilever was driven so as to produce a free oscillation amplitude at resonance in the 120-180 nm range. The setpoint for feedback tracking of topography was ˜0.75-0.8 of the free oscillation amplitude at resonance. Confirmed by the sign of phase signal accompanied by amplitude and phase vs. Z curves, the aforementioned parameter setting ensured that the oscillator was maintained in the net repulsive regime to achieve substantial dissipation-based contrast in phase images,¹ such that lower phase (darker) per Keysight convention corresponded to greater energy dissipation. Phase image color-rendering was performed using the freeware Gwyddion (version 2.58) but without data modification (i.e., raw data are presented).

Gel Permeation Chromatography (GPC) measurements were performed on a set of Phenomenex Phenogel 5μ, 1K-75K, 300×7.80 mm in series with a Phenomex Phenogel 5μ, 10K-1000K, 300×7.80 mm columns with HPLC grade solvents as eluents: dimethylformamide (DMF) with 0.05M of LiBr at 60° C. Detection consisted of a Wyatt Optilab T-rEX refractive index detector operating at 658 nm and a Wyatt DAWN® HELEOS® II light scattering detector operating at 659 nm.

TABLE 1
Tensile properties of as synthesized PU films.

| | Tensile Stress | Strain at Break | Young's Modulus |
|---|---|---|---|
| Sample | (MPa) | (%) | (MPa) |
| Polyester (rigid) PU | 40 ± 4 | 4 ± 1 | 1600 ± 100 |
| Polyether (soft) PU | 2.0 ± 0.1 | 430 ± 40 | 2.0 ± 0.1 |

TABLE 2
T_{g} of as synthesized PU films

| Sample | Polyester PU | Polyether PU |
|---|---|---|
| T_{g} (° C., tan(δ) peak of DMTA) | 64.3 | 10.7 |

TABLE 3
T_{g} of PU CAN as-synthesized blends.

| Composition (wt % rigid:soft) | 25:75 | 50:50 | 75:25 |
|---|---|---|---|
| T_{g} (° C., tan(δ) peak of DMTA) | 20.5 | 34.4 | 50.0 |

TABLE 4
Tensile properties of as-synthesized mixtures of PU blends.

| Composition | Tensile | Strain | Young's |
|---|---|---|---|
| (wt % rigid:wt | Stress | at Break | Modulus |
| % soft) | (MPa) | (%) | (MPa) |
| 25:75 | 2.1 ± 0.3 | 320 ± 10 | 1.58 ± 0.04 |
| 50:50 | 7.66 ± 0.01 | 330 ± 40 | 8 ± 6 |
| 75:25 | 17.9 ± 0.1 | 210 ± 10 | 730 ± 80 |

TABLE 5
T_{g} of PU CAN compression molded blends.

| Composition (wt % rigid:soft) | 25:75 | 50:50 | 75:25 |
|---|---|---|---|
| T_{g} (° C., tan(δ) peak of DMTA) | 17.8 | 47.4 | 56.8 |

TABLE 6
Tensile properties of the extruded PU blends.

| Composition | Tensile | Strain | Young's |
|---|---|---|---|
| (wt % rigid:wt | Stress | at Break | Modulus |
| % soft) | (MPa) | (%) | (MPa) |
| 25:75 | 1.7 ± 0.4 | 310 ± 30 | 1.1 ± 0.2 |
| 40:60 | 3.8 ± 0.5 | 290 ± 20 | 2.2 ± 0.7 |
| 50:50 | 7.2 ± 0.2 | 300 ± 20 | 5.3 ± 0.4 |
| 55:45 | 9.4 ± 0.3 | 240 ± 10 | 12 ± 1 |
| 60:40 | 13 ± 1 | 170 ± 10 | 110 ± 30 |
| 75:25 | 16 ± 3 | 170 ± 10 | 170 ± 40 |
| 85:15 | 18 ± 1 | 140 ± 10 | 610 ± 20 |
| 90:10 | 33 ± 9 | 73 ± 4 | 1100 ± 30 |

TABLE 7
Tensile properties of compression molded blends.

| Composition | Tensile | Strain | Young's |
|---|---|---|---|
| (wt % rigid:wt | Stress | at Break | Modulus |
| % soft) | (MPa) | (%) | (MPa) |
| 25:75 | 0.97 | 153 | 2 |
| 50:50 | 10.1 | 79.7 | 260 |
| 75:25 | 34.4 | 10.4 | 1300 |

TABLE 8
Gel fractions of the extruded blends.

| | Composition (wt % rigid:soft) | | | | | | | |
|---|---|---|---|---|---|---|---|---|
| | 25:75 | 40:60 | 50:50 | 55:45 | 60:40 | 75:25 | 85:15 | 90:10 |
| Gel | 82.8 | 81.3 | 80.5 | 80.6 | 80.1 | 88.2 | 89.0 | 94.4 |
| Fraction (%) | | | | | | | | |

TABLE 9
T_{g} of PU CAN extruded blends.

| | Composition (wt % rigid:soft) | | | | | | |
|---|---|---|---|---|---|---|---|
| | 25:75 | 40:60 | 50:50 | 60:40 | 75:25 | 85:15 | 90:10 |
| T_{g} (° C., tan(δ) | 19.3 | 25.8 | 35.8 | 40.5 | 48.5 | 51.7 | 57.5 |
| peak of DMTA) | | | | | | | |

TABLE 10
Toughness analysis of extruded blends compared
to as synthesized starting rigid and soft PUs.

| Sample Composition (Rigid:soft) | Toughness (J/m³) |
|---|---|
| 0:100 (as synthesized) | 460 ± 70 |
| 25:75 | 260 ± 80 |
| 40:60 | 500 ± 10 |
| 50:50 | 830 ± 80 |
| 55:45 | 1080 ± 70 |
| 60:40 | 1500 ± 200 |
| 75:25 | 2000 ± 500 |
| 90:10 | 1800 ± 400 |
| 100:0 (as synthesized) | 430 ± 90 |

TABLE 11
T_{g} values of multiply reprocessed materials
with predicted values based on trendline.

| | Composition | T_{g} | Predicted T_{g} from |
|---|---|---|---|
| Reprocessing | (wt % rigid:wt | (° C., tan(δ) | trendline analysis |
| Step | % soft) | peak of DMTA) | (° C.) |
| 1st RP | 90:10 | 57.5 | 56.5 |
| 2nd RP | 69:31 | 43.4 | 45.2 |
| 3rd RP | 53:47 | 35.5 | 36.6 |
| 4th RP | 41:59 | 29.5 | 30.2 |

TABLE 12
Tensile properties of extruded materials
from the multiple reprocessing steps.

| | Composition | Tensile | Strain | Young's |
|---|---|---|---|---|
| Reprocessing | (wt % rigid:wt | Stress | at Break | Modulus |
| Step | % soft) | (MPa) | (%) | (MPa) |
| 1st RP | 90:10 | 33 ± 9 | 73 ± 4 | 1400 ± 300 |
| 2nd RP | 69:31 | 17.4 ± 0.9 | 200 ± 30 | 170 ± 20 |
| 3rd RP | 53:47 | 9.32 ± 0.08 | 230 ± 10 | 12 ± 1 |
| 4th RP | 41:59 | 3.5 ± 0.3 | 250 ± 20 | 2.8 ± 0.3 |

TABLE 13
Tensile toughnesses of the multiply reprocessed blends compared
to the singly extruded materials of similar composition.

| | Sample | | | | | | |
|---|---|---|---|---|---|---|---|
| | 90:10 | 70:30 | 75:25 (1 | 53:47 | 55:45 (1 | 41:59 | 40:60 (1 |
| | (1^{st} RP) | (2^{nd} RP) | RP step) | (3^{rd} RP) | RP step) | (4^{th} RP) | RP step) |
| Toughness | 1800 ± | 2220 ± | 2000 ± | 1100 ± | 1100 ± | 460 ± | 500 ± |
| (J/m³) | 400 | 40 | 500 | 60 | 50 | 20 | 10 |

### REFERENCES

(1) Haugstad, G. Atomic Force Microscopy: Understanding Basic Modes and Advanced Applications, Ist ed.; Wiley, 2012.

1. A method for preparing a blended reprocessed polyurethane network, the method comprising extruding, with a twin-screw extruder, a blend of different polyurethanes in the presence of a carbamate exchange catalyst.

2. The method of claim 1, wherein the blend of different polyurethanes comprises
a rigid polyurethane and a soft polyurethane.

3. The method of claim 1, wherein a mechanical or thermal property of the extrudate is tuned by selecting the weight percent (wt %) of each of the different polyurethanes in the blend.

4. The method of claim 1 further comprising recovering the extrudate and extruding a blend of the extrudate and a second polyurethane in the presence of the carbamate exchange catalyst.

5. The method of claim 4, further comprising repeating the recovery and extrusion steps one or more times.

6. The method of claim 4, wherein a mechanical or thermal property of the extrudate is tuned by selecting the second polyurethane.

7. The method of claim 4, wherein a mechanical or thermal property of the extrudate is tuned by selecting the weight percent (wt %) of the extrudate and the second polyurethane.

8. The method of claim 4, wherein the blend of different polyurethanes comprises a rigid polyurethane and a soft polyurethane.

9. A method for reprocessing a polyurethane composition, the method comprising introducing the polyurethane composition into a compounding device, heating the polyurethane composition to an effective bond-exchange temperature, and compounding the polyurethane composition for an effective bond-exchange time, wherein the polyurethane composition comprises two or more network polymers and an effective amount of a polyurethane exchange catalyst permeated within the polyurethane composition, wherein the two or more network polymers each comprise a dynamic network formed from an isocyanate constitutional unit and a second constitutional unit having a hydroxyl group capable of reacting with an isocyanate group of the isocyanate constitutional unit to form a urethane bond.

10. The method of claim 9, wherein a mechanical or thermal property of the compounded polyurethane composition is tuned by selecting the weight percent (wt %) of each of the two or more network polymers in the polyurethane composition.

11. The method of claim 9 further comprising recovering the compounded polyurethane composition, introducing an additional network polymer and the compounded polyurethane composition into a second compounding device, heating the compounded polyurethane composition and additional network polymer to a second effective bond-exchange temperature, and compounding the compounded polyurethane composition and the additional network polymer to a second effective bond-exchange time.

12. The method of claim 11, further comprising repeating the introducing, heating, and compounding steps one or more times.

13. The method of claim 11, wherein a mechanical or thermal property of the extrudate is tuned by selecting a weight percent (wt %) of the additional network polymer.

14. The method of claim 9, wherein the blend of different powered polyurethanes comprises a rigid polyurethane and a soft polyurethane.

15. The method of claim 9, wherein the second constitutional unit is a prepolymer molecule comprising a polyether, a polyester, a polycarbonate, a polyacrylate, a polyolefin, a polybutadiene, a polysulfide, or a polysiloxane.

16. The method of claim 9, wherein the second constitutional unit is a branch unit having at least two hydroxyl groups each capable of reacting with the isocyanate group of the first constitutional unit to form the urethane bond.

17. The method of claim 9, wherein the isocyanate constitutional unit comprises at least two isocyanate groups.

18. A composition comprising the extrudate prepared by the method of claim 1 and a second polyurethane.

19. A composition comprising the compounded polyurethane composition prepared by the method of claim 9 and an additional network polymer.

20. The method or composition of claim 1, wherein the catalyst comprises a metal selected from Sn, Bi, Fe, Zr, Ti, Hf, Al, Zn, Cu, Ni, Co, Mn, V, Sc, Y, Ce, or Mo and a ligand coordinated with the metal atom, optionally wherein the catalyst comprises DBTDL, Bi(neo)₃, Fe(acac)₃, Ti(OiPr)₂(acac)₂, Hf(acac)₄, Zr(acac)₄, Mn(acac)₂, Bi(oct)₃, Zn(tmhd)₂, Zr(tmhd)₄, or any combination thereof.
